(19) United States
(12) Patent Application Publication
(10) Pub. No.: US 2006/0016669 A1
(43) Pub. Date: Jan. 26, 2006

(54) Belt conveyor

(75) Inventor: Katsuji Bando, Nagoya-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOYOAKE INDUSTRY CO., LTD., Toyoake-shi (JP)

(21) Appl. No.: 11/185,989

(22) Filed: Jul. 21, 2005

(30) Foreign Application Priority Data
Jul. 22, 2004 (JP) 2004-214511

(51) Int. Cl. B65G 23/00

(52) U.S. Cl. 198/832

(57) ABSTRACT

In a belt conveyor, when an input lever is rotated in a fixed direction, an input shaft is rotated and a fourth gear fixed on the input shaft is rotated integrally in the same direction. Then, second and third gears are rotated in fixed directions and a first gear and a drive shaft are rotated in fixed directions. Thereby, a spiral spring connected to the drive shaft is wound up stronger little by little so as to store an elastic energy. If a rotating angle in the given direction comes to about 150 degrees, an end of a toothless portion of the fourth gear arrives a meshing part with the third gear so as to disengage from the third gear. Thus, a rotary shaft and the drive shaft are respectively rotated in reverse directions to the give directions by the releasing energy of the spiral spring. Consequently, the drive roller is rotated in a counterclockwise direction so as to drive a conveyor belt in a given direction.

### BACKGROUND ART

1. Field of the Invention

The present invention relates to an energy-saving belt conveyor of wind-up type or a spring driven belt conveyor which can drive a conveyor belt by a spiral spring that is manually wound up only when needed or to an energy-saving belt conveyor which can drive a conveyor belt by manually releasing a stored energy in an elastic energy storage mechanism so as to wind up a wire of the elastic energy storage mechanism only when needed.

2. Description of the Related Art

A conventional belt conveyor generally has a continuous or endless conveyor belt. The conveyor belt is driven by a driving roller that is rotated by an electric motor or an air-driven motor so as to convey workpieces put on an upper surface of the conveyor belt.

For example, Japanese Patent No. 3058637 shows an invention of a belt conveyor. The belt conveyor is designed to reduce damage to a conveyor belt. The belt conveyor drives a conveyor belt by a driving roller with a built-in motor or by a driving roller connected to a motor having a reducer or the like.

However, all conventional belt conveyors including the belt conveyor as shown in Patent No. 3058637 are driven by the electric motor or the air-driven motor or the like. Therefore the conventional belt conveyors need electric power after all. Especially, it's often the case that a belt conveyor is continuously driven all day or 24 hours in a large factory. Consequently, the belt conveyor is sometimes driven alone without conveying any workpieces. As a result, there is huge waste of electrical energy. Moreover, a control system becomes too complex in a drive system using the conventional electric motor, the air-driven motor or the like to finely control the belt conveyor. Then, it was hard to move the belt conveyor by a desired distance, to convey workpieces on the belt conveyor to a desired position, to inch the conveyor belt, for example.

### BRIEF SUMMARY OF THE INVENTION

An object of the present invention is to provide a spring driven belt conveyor that can drive a conveyor belt by a spiral spring by manually winding up the spring only when needed, thereby saving energy without using any electrical power and enables a fine control with ease.

Another object of the present invention is to provide a belt conveyor that can drive a conveyor belt by manually storing an energy in an expansion-contraction energy storing mechanism or an elastic energy storage mechanism and releasing the energy only when needed, thereby saving energy without using much or any electrical power and enables a fine control with ease.

A first aspect of an inventive spring driven belt conveyor comprises: a pair of frames separated away and opposed to each other; a drive shaft axially supported on one of the pair of the frames; a driven shaft axially supported on another of the pair of the frames; a drive roller attached to the drive shaft so as to rotate integrally with the drive shaft; a driven roller attached to the driven shaft so as to rotate integrally with the driven shaft; an endless conveyor belt stretched between the drive roller and the driven roller so as to run; a support, for supporting the conveyor belt, having opposite ends fixed on the pair of the frames between the drive roller and the driven roller; a spiral spring to which the drive shaft of the drive roller is connected so as to rotate; an input shaft axially supported on one of the pair of the frames so as to be separated away from the drive shaft; a rotating speed increasing mechanism provided between the input shaft and the drive shaft of the drive roller so as to transmit rotation of the input shaft to the drive shaft while increasing a rotation speed thereof and an input member attached to the input shaft.

The spiral spring may be disposed at an inside or an outside of the pair of the frames. In case the spiral spring is disposed at the outside of the pair of the frames, its repair is easy. However, since a protruded portion is generated, so that a position of the spiral spring should be selected and determined depending on a installed condition. Moreover, the spiral spring may be attached directly on the drive shaft or disposed on another gear shaft that gives a rotating force directly to the conveyor belt. Still, if it is directly connected, an energy loss can be lessened.

A spring driven belt conveyor may further comprises a one-way clutch through which the drive roller is attached to the drive shaft so that the drive roller is not rotated when the drive shaft is rotated in a direction to wind up the spiral spring, while the drive roller being rotated when the drive shaft is rotated in a direction to release the spiral spring.

In a spring driven belt, the rotating speed increasing mechanism may be composed of a combination of a plurality of gears including a gear fixed on the input shaft and a gear fixed on the drive shaft and rotary shaft provided respectively for the gears; and the gear fixed on the input shaft may have a toothless portion so that the gear fixed on the input shaft is disengaged from the gear meshing with the gear fixed on the input shaft at a position where the spiral spring is sufficiently wound up by operation of the input member.

In a spring driven belt conveyor, the rotating speed increasing mechanism may further include a one-way clutch through which one or more of the gears other than the gear fixed on the input shaft and the gear fixed on the drive shaft among the plurality of the gears is attached to the rotary shaft so that the same gear is integrally rotated when the rotary shaft of the same gear is rotated in a direction to wind up the spiral spring, while the same gear stops transmitting a rotating force when the drive shaft is rotated in a direction to release the spiral spring.

A spring driven belt conveyor may further comprise a weight attached inside the drive roller over an entire circumference of the drive roller so as to increase inertia of he drive roller.

A spring driven belt conveyor may further comprise a plurality of supporting legs attached to opposite sides of the support so as to hold the conveyor belt at a required height.

In a spring driven belt conveyor, the input member may have an input lever having one end fixed on the input shaft.

In the invention according to the first aspect or its modification, the rotating speed increasing mechanism is provided between the drive shaft to which the drive roller is attached for driving the conveyor belt and the input shaft on which the one end of the input lever is fixed. Therefore, if an operator holds the other end of the input lever and rotates the input lever in a given direction, the rotation of the input shaft is multiplied and transmitted to the drive shaft. Then, the spiral spring attached to the drive shaft is wound up. If the operator releases his or her hand at this time, the spiral spring is released and the drive shaft is rotated by an elastic force stored therein. Then, the drive roller is integrally rotated so as to drive the conveyor belt. A running distance of the conveyor belt can be adjusted as desired if a relation between an rotating angle of the input lever and a rotating number of the drive shaft is found out in advance.

Thus, it is possible to drive the conveyor belt by a necessary distance when needed without using an electric power. Moreover, if the input lever is rotated by a desired angle within a range of a wind-up limit of the spiral spring and returned little by little, it is easy to feed the conveyor belt by a slight distance or inch the conveyor belt.

Consequently, the spring driven belt conveyor can drive the conveyor belt by the spiral spring by manually winding up the spring only when needed, thereby saving energy without using any electrical power and enables a fine control with ease.

When the input lever is rotated in a given direction by a given angle so as to wind up the spiral spring, the drive roller is not rotated. Therefore, the conveyor belt is not driven in a reverse direction. Moreover, it is possible to rotate the input lever with a little force without an extra force so as to wind up the spiral spring.

When the operator releases his or her hand from the input lever so as to rotate the drive shaft in a direction to release the spiral spring, the one-way clutch is engaged so that the drive roller is rotated integrally with the drive shaft. Consequently, the conveyor belt runs in a given direction. If the input lever is rotated by a desired angle within a range of a wind-up limit of the spiral spring and returned little by little, it is easy to feed the conveyor belt by a slight distance or inch the conveyor belt.

Consequently, a spring driven belt conveyor can drive the conveyor belt by the spiral spring by manually winding up the spring only when needed, as well as being able to drive the conveyor belt with a little force so as to drive the conveyor belt, thereby saving energy without using any electrical power and enables a fine control with ease.

When the spiral spring is wound up sufficiently, the gear engaged with the gear fixed on the input shaft becomes in such a state as to run idle. Therefore, the spiral spring is released and the drive roller is rotated so as to drive the conveyor belt.

Thereby, the rotating force is not transmitted to the gear fixed on the input shaft and to the input shaft among the gears constituting the rotating speed increasing mechanism and the rotary shafts. Then, the input lever does not return to its original position. Consequently, the elastic force stored in the spiral spring is not used for rotating the input lever to the original position. Thus, the elastic force is effectively used without being wasted for unnecessary force. Moreover, it is possible to avoid such a danger as the input lever hits an operator when it is rotated to the original position. Furthermore, it is possible to surely avoid a case in which the input lever is rotated over the given angle thereby to wind up the spiral spring too much and damage it. If the input lever is rotated by a desired angle within such a range as the gear does not run idle and returned little by little, it is easy to feed the conveyor belt by a slight distance or inch the conveyor belt.

Consequently, a spring driven belt conveyor can drive the conveyor belt by the spiral spring by manually winding up the spring only when needed, while preventing the spiral spring from being wound up too much and damaged, and can drive the conveyor belt effectively using the elastic force stored in the spiral spring, thereby saving energy without using any electrical power and enables a fine control with ease.

When the input lever is rotated to wind up the spiral spring, the rotating speed increasing mechanism transmits the rotating force while increasing the rotating speed. When the spiral spring is released and the drive roller is rotated so as to drive the conveyor belt, one of the rotary shaft and the gear runs idle so as not to transmit the rotating force to the input shaft and the input lever. Therefore, the elastic force stored in the spiral spring is not used more than is necessary for rotating all the plural gears constituting the rotating speed increasing mechanism and the input shaft and the input lever. Consequently, the elastic force is all used for rotating the drive roller after rotating the drive shaft and the gears near it. As a result, the conveyor belt can be driven efficiently.

Consequently, a spring driven belt conveyor can drive the conveyor belt by the spiral spring by manually winding up the spring only when needed, then driving the conveyor belt effectively using the elastic force stored in the spiral spring, thereby saving energy very much without using any electrical power and enabling a fine control with ease.

When the spiral spring is released to rotate the drive roller, the drive roller rotates by the inertia force several times more than a rotating number by a releasing of the spiral spring. Consequently, the conveyor belt can be driven at a longer distanced.

Consequently, a spring driven belt conveyor can drive the conveyor belt by the spiral spring by manually winding up the spring only when needed, then driving the conveyor belt effectively using the elastic force stored in the spiral spring, thereby saving energy very much without using any electrical power and enabling a fine control with ease.

The conveyor belt can be held at the required height to a certain height by making the pair of the frames high. However, it has a limit. Particularly, a material of the frame is wasted at the frame side on which the driven roller and the driven shaft are only attached. Then, the conveyor belt can be supported at the required height by attaching the supporting legs of he required height at the both sides of the support that is held between the pair of the frames for holding the conveyor belt.

The conveyor belt is not always supported substantially horizontally. The conveyor belt is supported slant as desired, that is, with a driven roller side higher or a driven roller side lower. Moreover, in case the support is wider than the conveyor belt and the opposite side surfaces are protruded from the conveyor belt, the plural supporting legs can be attached directly to the opposite side surfaces of the support. However, if the support is narrower than the conveyor belt and the opposite side surfaces of the support are retracted from the conveyor belt, interconnecting members need to be attached to the opposite side surfaces of the support so as to be protruded from the conveyor belt by a number of the supporting legs. Then, the supporting legs are attached to the interconnecting members.

Consequently, a spring driven belt conveyor can drive the conveyor belt by the spiral spring by manually winding up the spring only when needed, while supporting the conveyor belt at the required height, then driving the conveyor belt effectively using the elastic force stored in the spiral spring, thereby saving energy very much without using any electrical power.

In a spring driven belt conveyor, the input member may have a rotary handle disc attached to one end of the input shaft.

If the input shaft is rotated only about one half, the drive shaft is rotated several times so as to wind up the spiral spring at a burst only by the rotating speed increasing mechanism provided between the input shaft and the drive shaft. In contrast, a force for rotating the input shaft is several times larger than a force necessary for directly rotating the drive shaft.

Then, the input lever having a certain length is fixed on the input shaft. Thereby, the input shaft can be rotated easily by a principle of leverage. Instead, if the rotary handle disc is used, the rotary handle disc has a small diameter, so that a larger force is necessary to rotate the input shaft. Still, it saves a space. Moreover, in a structure in which the rotating force returns to the input shaft when the conveyor belt runs, it is safer for the operator to rotate the small diameter rotary handle disc than to rotate the long input lever to the original position.

Consequently, a spring driven belt conveyor can drive the conveyor belt by the spiral spring by manually winding up the spring only when needed, then more safely driving the conveyor belt effectively using the elastic force stored in the spiral spring, thereby saving energy very much without using any electrical power.

A spring driven belt conveyor may further comprise a clutch mechanism provided between the input shaft and the rotary handle disc.

After the rotary handle disc is rotated in a fixed direction by a fixed angle so as to wind up the spiral spring via the rotating speed increasing mechanism, it is possible to release connection of the input shaft and the rotary handle disc via the clutch mechanism. Then, the spiral spring is released to rotate the drive roller via the input shaft and the rotating speed increasing mechanism, thereby driving the conveyor belt. At this time, the rotary handle disc is not rotated, so that it is safer than a type in which the rotating force returns to the input shaft when the conveyor belt is driven.

Consequently, a spring driven belt conveyor can drive the conveyor belt by the spiral spring by manually winding up the spring only when needed, then more safely driving the conveyor belt effectively using the elastic force stored in the spiral spring, thereby saving energy very much without using any electrical power.

In a spring driven belt conveyor, the input member may have a step pedal attached to the input shaft so as to transmit a rotating force to the input shaft.

The input shaft can be rotated in a given direction by a given angle, thereby winding up the spiral spring so as to make the conveyor belt run. Moreover, it is easy to inch the conveyor belt by returning a foot pressing the step pedal little by little. Furthermore, the operator is free of his or her both hands, so that he or she can perform another work at the same time while driving the spring driven belt conveyor.

Consequently, a spring driven belt conveyor can drive the conveyor belt by the spiral spring by manually winding up the spring only when needed, then driving the conveyor belt effectively using the elastic force stored in the spiral spring, thereby saving energy without using any electrical power and enables a fine control with ease.

In a spring driven belt conveyor, the input member may further have a step pedal attached to a leading end of the input lever so as to transmit a rotating force to the input shaft.

A second aspect of an inventive belt conveyor comprises: a pair of frames separated away and opposed to each other; a drive shaft axially supported on the pair of the frames; a driven shaft axially supported on the pair of the frames; a drive roller attached to the drive shaft so as to rotate integrally with the drive shaft; a driven roller attached to the driven shaft so as to rotate integrally with the driven shaft; an endless conveyor belt stretched between the drive roller and the driven roller so as to run; a support limiting a downward movement of the conveyor belt and supporting a rear surface of the conveyor belt between the drive roller and the driven roller;

an expansion-contraction energy storing mechanism being able to determining a stored state of an energy by an expansion-contraction state in a longitudinal direction; and a rotatable pulley changing an expansion-contraction state in a longitudinal direction by the energy stored in the expansion-contraction energy storing mechanism if a human energy is applied to the expansion-contraction energy storing mechanism so as to mechanically rotate the drive roller only in a specified direction.

A second aspect of an inventive belt conveyor comprises: a pair of frames separated away and opposed to each other; a drive shaft axially supported on the pair of the frames; a driven shaft axially supported on the pair of the frames; a drive roller attached to the drive shaft so as to rotate integrally with the drive shaft; a driven roller attached to the driven shaft so as to rotate integrally with the driven shaft; an endless conveyor belt stretched between the drive roller and the driven roller so as to run; a support limiting a downward movement of the conveyor belt and supporting a rear surface of the conveyor belt between the drive roller and the driven roller; an expansion-contraction energy storing mechanism being able to determining a stored state of an energy by an expansion-contraction state in a longitudinal direction; a first rotatable pulley adapted to slide when the energy stored in the expansion-contraction energy storing mechanism is discharged; a retainer provided on the pair of the frames near the drive shaft; a second pulley fixed integrally and rotatably on the drive shaft; a wire having one end fixed on the retainer and another end fixed on the second pulley, while being passed around the first pulley and then wound around the second pulley; an input shaft axially supported on the pair of the frames so as to be separated away from the drive shaft; a rotating speed increasing mechanism provided between the input shaft and the drive shaft so as to transmit rotation of the input shaft to the drive shaft while increasing a rotation speed thereof; and an input member attached to the input shaft.

In a belt conveyor, the expansion-contraction energy storing mechanism may have a guide having a flange fixed on the pair of the frames so as to be parallel to the conveyor belt, a long rod fitted into the flanged guide so as to slide in a direction parallel to the conveyor belt, a spring holder fixed on the long rod near the driven roller, and a coil spring attached between the spring holder and the flange of the guide so as to surround the long rod.

A belt conveyor may further comprise a one-way clutch through which the drive roller is attached to the drive shaft so that the drive roller is not rotated when the drive shaft is rotated to make the expansion-contraction energy storing mechanism store the energy, while the drive roller being rotated when the drive shaft is rotated to discharge the energy stored in the expansion-contraction energy storing mechanism.

In a belt conveyor according to claim 14, the rotating speed increasing mechanism may be composed of a combination of a plurality of gears including a gear fixed on the input shaft and a gear fixed on the drive shaft and rotary shaft provided respectively for the gears; and the gear fixed on the input shaft may have a toothless portion so that the gear fixed on the input shaft is disengaged from the gear meshing with the gear fixed on the input shaft at a position where the coil spring is sufficiently compressed by operation of the input member.

In a belt conveyor, the gear meshing with the gear fixed on the input shaft may have all teeth of a part cut off corresponding to a locus drawn by a tooth edge of an end tooth next to the toothless portion of the gear fixed on the input shaft when the end tooth is again engaged with the gear.

In a belt conveyor, the rotating speed increasing mechanism may further include a one-way clutch through which one or more of the gears other than the gear fixed on the input shaft and the gear fixed on the drive shaft among the plurality of the gears is attached to the rotary shaft so that the same gear is integrally rotated when the rotary shaft of the same gear is rotated in a direction to compress the coil spring, while the same gear stops transmitting a rotating force when the drive shaft is rotated in a direction to release the coil spring.

A belt conveyor may further comprise a weight attached inside the drive roller over an entire circumference of the drive roller so as to increase inertia of he drive roller.

A spring driven belt conveyor may further comprise a plurality of supporting legs attached to the support and/or at least one of the pair of the frames so as to hold the conveyor belt at a required height.

In a belt conveyor, the input member may have an input lever having one end fixed on the input shaft.

In the invention according to the second or the third aspect or its modification, the expansion-contraction energy storing mechanism may be composed of one having the coil spring or a spring plate assembled in a slide mechanism, one having an elastic rubber assembled therein, one that supplies compressed air by an air pump into an air cylinder with a stopper provided in a retracted state, one that compresses and expands an air cylinder by the input lever, one that attach a pinion rod to the coil spring or an air cylinder so as to rotate by a direct mesh with the pulley, or the like.

If a human energy is applied to the expansion-contraction energy storing mechanism, its expansion-contraction change in the longitudinal varies by the energy stored in the expansion-contraction energy storing mechanism. Consequently, the driven roller is mechanically rotated only in a specified direction via rotation of the pulley. As a result, the conveyor belt held on the drive roller rns in a predetermined direction.

Consequently, a belt conveyor can drive the conveyor belt by manually storing an energy in an expansion-contraction energy storing mechanism or an elastic energy storage mechanism and releasing the energy only when needed, thereby saving energy without using much or any electrical power and enabling a fine control with ease.

The rotating speed increasing mechanism is provided between the drive shaft to which the drive roller is attached for driving the conveyor belt and the input shaft on which the one end of the input lever is fixed. Therefore, if an operator holds the other end of the input lever and rotates the input lever in a given direction, the rotation of the input shaft is multiplied and transmitted to the drive shaft. Then, the second pulley attached integrally to the drive shaft is rotated so as to wind up the wire. Thereby, the first pulley on which the wire is put is pulled to the second pulley side. In this state, an energy is stored in the expansion-contraction energy storing mechanism.

If a stopper or the like is manually released, the second pulley and the drive shaft are rotated integrally by the energy stored in the expansion-contraction energy storing mechanism. Then, the drive roller is integrally rotated so as to drive the conveyor belt. A running distance can be adjusted as desired by finding out a relation between the energy stored in the expansion-contraction energy storing mechanism and the rotating number of the drive shaft.

Consequently, a belt conveyor can drive the conveyor belt by manually storing an energy in an expansion-contraction energy storing mechanism or an elastic energy storage mechanism and releasing the energy only when needed, thereby saving energy without using much or any electrical power and enabling a fine control with ease.

The rotating speed increasing mechanism is provided between the drive shaft to which the drive roller is attached for driving the conveyor belt and the input shaft on which the one end of the input lever is fixed. Therefore, if an operator holds the other end of the input lever and rotates the input lever in a given direction, the rotation of the input shaft is multiplied and transmitted to the drive shaft. Then, the second pulley attached integrally to the drive shaft is rotated so as to wind up the wire. Thereby, the first pulley on which the wire is put is pulled to the second pulley side. Then, the long rod integrally slides and the spring holder comes near the flange of the guide so as to compress the coil spring. At this time, if the operator releases his or her hand, the coil spring acts repulsively and expands. Then, the drive shaft is rotated integrally with the second pulley by the elastic force stored in the coil spring. Thereby, the drive roller is integrally rotated so as to drive the conveyor belt. A running distance can be adjusted as desired by finding out a relation between the energy stored in the expansion-contraction energy storing mechanism and the rotating number of the drive shaft.

Thus, it is possible to drive the conveyor belt by a necessary distance when needed without using an electric power. Moreover, if the input lever is rotated by a desired angle within a range of a compressing limit of the coil spring and returned little by little, it is easy to feed the conveyor belt by a slight distance or inch the conveyor belt.

Consequently, a belt conveyor can drive the conveyor belt by manually compressing the coil spring only when needed, thereby saving energy without using any electrical power with a resultant large energy saving and can assure a fine control with ease.

When the input lever is rotated in a given direction by a given angle so as to compress the coil spring, the drive roller is not rotated. Therefore, the conveyor belt is not driven in a reverse direction. Moreover, it is possible to rotate the input lever with a little force without an extra force so as to compress the coil spring.

When the operator releases his or her hand from the input lever so as to rotate the drive shaft in a direction to release the coil spring, the one-way clutch is engaged so that the drive roller is rotated integrally with the drive shaft. Consequently, the conveyor belt runs in a given direction. If the input lever is rotated by a desired angle within a range of a compressing limit of the coil spring and returned little by little, it is easy to feed the conveyor belt by a slight distance or inch the conveyor belt.

Consequently, a belt conveyor can drive the conveyor belt by manually storing an energy in an expansion-contraction energy storing mechanism or an elastic energy storage mechanism and releasing the energy only when needed, thereby saving energy without using much or any electrical power and enables a fine control with ease.

When the coil spring is compressed sufficiently, the gear engaged with the gear fixed on the input shaft becomes in such a state as to run idle. Therefore, the coil spring is released and the drive roller is rotated so as to drive the conveyor belt.

Thereby, the rotating force is not transmitted to the gear fixed on the input shaft and to the input shaft among the gears constituting the rotating speed increasing mechanism and the rotary shafts. Then, the input lever does not return to its original position. Consequently, the elastic force stored in the coil spring is not used for rotating the input lever to the original position. Thus, the elastic force is effectively used without being wasted for unnecessary force. Moreover, it is possible to avoid such a danger as the input lever hits an operator when it is rotated to the original position. Furthermore, it is possible to surely avoid a case in which the input lever is rotated over the given angle thereby to compress the coil spring too much and damage it. If the input lever is rotated by a desired angle within such a range as the gear does not run idle and returned little by little, it is easy to feed the conveyor belt by a slight distance or inch the conveyor belt.

Consequently, a belt conveyor can drive the conveyor belt by the coil spring by manually compressing the coil spring only when needed, while preventing the coil spring from being compressed too much and damaged, and can drive the conveyor belt effectively using the elastic force stored in the coil spring, thereby saving energy without using any electrical power and enables a fine control with ease.

When the toothless portion of the gear fixed on the input shaft arrives at the meshing part with the engaging gear, the engaging gear runs idle and the coil spring is released so as to rotate the drive roller and drive the conveyor belt. In order to drive the conveyor belt again, a toothed portion of the gear fixed on the input shaft is again meshed with the engaging gear and the input lever is rotated to its original position. Then, the input lever needs to be rotated from that position so as to compress the coil spring again.

However, the end tooth next to the toothless portion of the gear fixed on the input shaft is not always meshed well with the teeth of the engaging gear. In some cases, it is possible that top parts of the teeth of both the gears collide with each other and that the gears are not meshed. Then, all the teeth of the engaging gear are cut off at the part corresponding to the locus drawn by the tooth edge of the rotating end tooth so that the end tooth is meshed with the tooth of the engaging gear 100% successfully. Thereby, even if the top parts of the teeth of both the gears come to such a position as to collide with each other, the end tooth moves past the teeth without collision so as to contact with a non-cutoff side of a next tooth, since the tooth edge of the engaging gear is cut off. Thus, both the gear are meshed with each other well.

Consequently, the gear having the toothless portion and the gear engaging therewith can be always meshed without fail. Then, a belt conveyor can drive the conveyor belt by the coil spring by manually compressing the coil spring only when needed, while preventing the coil spring from being compressed too much and damaged, and can drive the conveyor belt effectively using the elastic force stored in the coil spring, thereby saving energy very much without using any electrical power.

When the input lever is rotated to compress the coil spring, the rotating speed increasing mechanism transmits the rotating force while increasing the rotating speed. When the coil spring is released and the drive roller is rotated so as to drive the conveyor belt, one of the rotary shaft and the gear runs idle so as not to transmit the rotating force to the input shaft and the input lever. Therefore, the elastic force stored in the coil spring is not used more than is necessary for rotating all the plural gears constituting the rotating speed increasing mechanism and the input shaft and the input lever. Consequently, the elastic force is all used for rotating the drive roller after rotating the drive shaft and the gears near it. As a result, the conveyor belt can be driven efficiently.

It is possible to repeat inching and finely adjusting a position of a workpiece on the conveyor belt by repeating an operation to rotate the input lever a little and return it.

Consequently, a belt conveyor can drive the conveyor belt by the coil spring by manually compressing the coil spring only when needed, then driving the conveyor belt effectively using the elastic force stored in the coil spring, thereby saving energy very much without using any electrical power and enabling a fine control with ease.

When the energy stored in the expansion-contraction energy storing mechanism is released to rotate the drive roller, the drive roller rotates by the inertia force several times more than a rotating number by the stored energy. Consequently, the conveyor belt can be driven at a longer distanced.

Consequently, a belt conveyor can drive the conveyor belt by manually storing an energy in an expansion-contraction energy storing mechanism or an elastic energy storage mechanism and releasing the energy only when needed, thereby saving energy very much without using much or any electrical power and enabling a fine control with ease.

The conveyor belt can be held at the required height to a certain height by making the pair of the frames high. However, it has a limit. Particularly, a material of the frame is wasted at the frame side on which the driven roller and the driven shaft are only attached. Then, the conveyor belt can be supported at the required height by attaching the supporting legs of he required height at the both sides of the support that is held between the pair of the frames for holding the conveyor belt.

The conveyor belt is not always supported substantially horizontally. The conveyor belt is supported slant as desired, that is, with a driven roller side higher or a driven roller side lower. Moreover, in case the support is wider than the conveyor belt and the opposite side surfaces are protruded from the conveyor belt, the plural supporting legs can be attached directly to the opposite side surfaces of the support. However, if the support is narrower than the conveyor belt and the opposite side surfaces of the support are retracted from the conveyor belt, interconnecting members need to be attached to the opposite side surfaces of the support so as to be protruded from the conveyor belt by a number of the supporting legs. Then, the supporting legs are attached to the interconnecting members.

Consequently, a belt conveyor can drive the conveyor belt by manually releasing the energy stored in the expansion-contraction energy storing mechanism only when needed, while supporting the conveyor belt at the required height, thereby saving energy very much without using any electrical power.

In a belt conveyor, the input member may have a rotary handle disc attached to one end of the input shaft.

If the input shaft is rotated only about one half, the drive shaft is rotated several times so as to compress the coil spring or the spring plate at a burst only by the rotating speed increasing mechanism provided between the input shaft and the drive shaft. In contrast, a force for rotating the input shaft is several times larger than a force necessary for directly rotating the drive shaft.

Then, the input lever having a certain length is fixed on the input shaft. Thereby, the input shaft can be rotated easily by a principle of leverage. Instead, if the rotary handle disc is used, the rotary handle disc has a small diameter, so that a larger force is necessary to rotate the input shaft. Still, it saves a space. Moreover, in a structure in which the rotating force returns to the input shaft when the conveyor belt runs, it is safer for the operator to rotate the small diameter rotary handle disc than to rotate the long input lever to the original position.

Consequently, a belt conveyor can drive the conveyor belt by the coil spring by manually compressing the coil spring only when needed, then more safely driving the conveyor belt effectively using the elastic force stored in the coil spring, thereby saving energy very much without using any electrical power.

A belt conveyor may further comprise a clutch mechanism provided between the input shaft and the rotary handle disc.

After the rotary handle disc is rotated in a fixed direction by a fixed angle so as to compress the coil spring via the rotating speed increasing mechanism, it is possible to release connection of the input shaft and the rotary handle disc via the clutch mechanism. Then, the coil spring is released to rotate the drive roller via the input shaft and the rotating speed increasing mechanism, thereby driving the conveyor belt. At this time, the rotary handle disc is not rotated, so that it is safer than a type in which the rotating force returns to the input shaft when the conveyor belt is driven.

Consequently, a belt conveyor can drive the conveyor belt by the coil spring by manually compressing the coil spring only when needed, then more safely driving the conveyor belt effectively using the elastic force stored in the coil spring, thereby saving energy very much without using any electrical power.

In a belt conveyor, the input member may have a step pedal attached to the input shaft so as to transmit a rotating force to the input shaft.

In a belt conveyor, the input member may further have a step pedal attached to a leading end of the input lever so as to transmit a rotating force to the input shaft.

The input shaft can be rotated in a given direction by a given angle, thereby compressing the coil spring so as to make the conveyor belt run. Moreover, it is easy to inch the conveyor belt by returning a foot pressing the step pedal little by little. Furthermore, the operator is free of his or her both hands, so that he or she can perform another work at the same time while driving the spring driven belt conveyor.

Consequently, a belt conveyor can drive the conveyor belt by the coil spring by manually compressing the coil spring only when needed, then more safely driving the conveyor belt effectively using the elastic force stored in the coil spring, thereby saving energy very much without using any electrical power.

Further objects and advantages of the invention will be apparent from the following description, reference being had to the accompanying drawings, wherein preferred embodiments of the invention are clearly shown.

### BRIEF DESCRIPTION OF THE DRAWINGS

FIG. 1 is a side elevation view showing an overall structure of a spring driven belt conveyor with a middle portion thereof cut away or omitted according to a first embodiment of the invention.

FIG. 2 is a top plan view showing an overall structure of the spring driven belt conveyor with a middle portion thereof cut away according to the first embodiment of the invention.

FIG. 3 is a vertical sectional view showing a structure of a drive section of the spring driven belt conveyor according to the first embodiment of the invention.

FIG. 4 is an enlarged left side elevation view showing the drive section of the spring driven belt conveyor according to the first embodiment of the invention.

FIG. 5 is a vertical sectional view showing a structure of a drive section of a spring driven belt conveyor according to a second embodiment of the invention.

FIG. 6 is an enlarged left side elevation view showing a drive section of a spring driven belt conveyor according to a third embodiment of the invention.

FIG. 7 is an enlarged left side elevation view showing a drive section of a spring driven belt conveyor according to a fourth embodiment of the invention.

FIG. 8 is a side elevation view showing an overall structure of a belt conveyor with a front side frame plate of a third frame dismounted and with a middle portion thereof cut away according to a fifth embodiment of the invention.

FIG. 9 is a top plan view showing an overall structure of the belt conveyor with a middle portion thereof cut away according to the fifth embodiment of the invention.

FIG. 10A is a top plan view showing a structure of a drive section of the belt conveyor according to the fifth embodiment of the invention.

FIG. 10B is a side elevation view showing the structure of the drive section of the belt conveyor according to the fifth embodiment of the invention.

FIG. 11 is a vertical sectional view showing a rotating speed increasing transmission mechanism of the belt conveyor according to the fifth embodiment of the invention.

FIG. 12 is a left side elevation view showing the rotating speed increasing transmission mechanism of the belt conveyor according to the fifth embodiment of the invention.

FIG. 13 is a partially enlarged left side elevation view showing the rotating speed increasing transmission mechanism of the belt conveyor according to the fifth embodiment of the invention.

FIG. 14 is a vertical sectional view showing a structure of a drive section of a belt conveyor according to a sixth embodiment of the invention.

FIG. 15 is an enlarged left side elevation view showing a drive section of a belt conveyor according to a seventh embodiment of the invention.

FIG. 16 is an enlarged left side elevation view showing a drive section of a belt conveyor according to an eighth embodiment of the invention.

### DETAILED DESCRIPTION OF THE INVENTION

Several embodiments of the invention are described hereunder referring to the attached drawings.

### First Embodiment

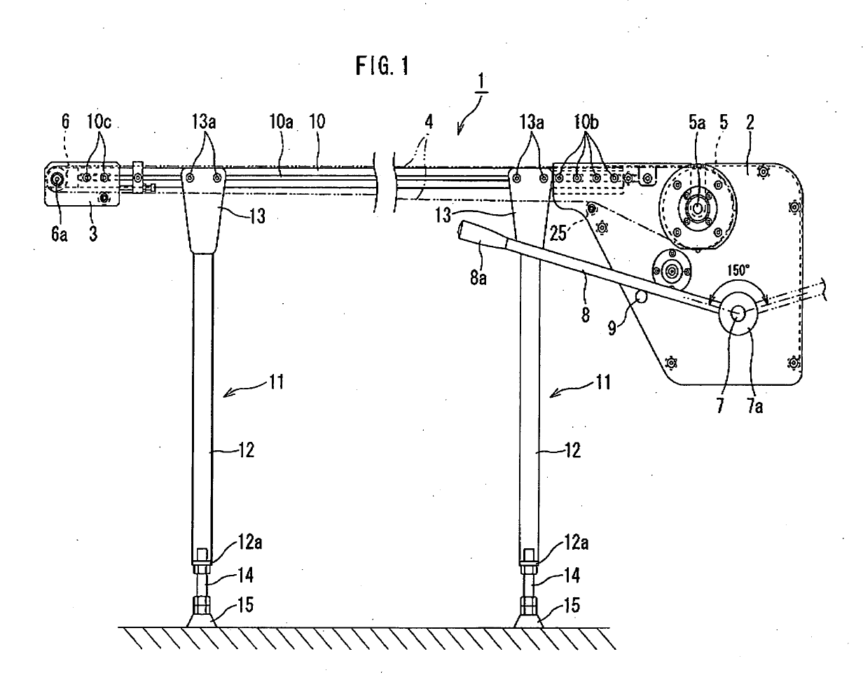

A first embodiment of the invention is described hereafter referring to FIG. 1 to FIG. 4.

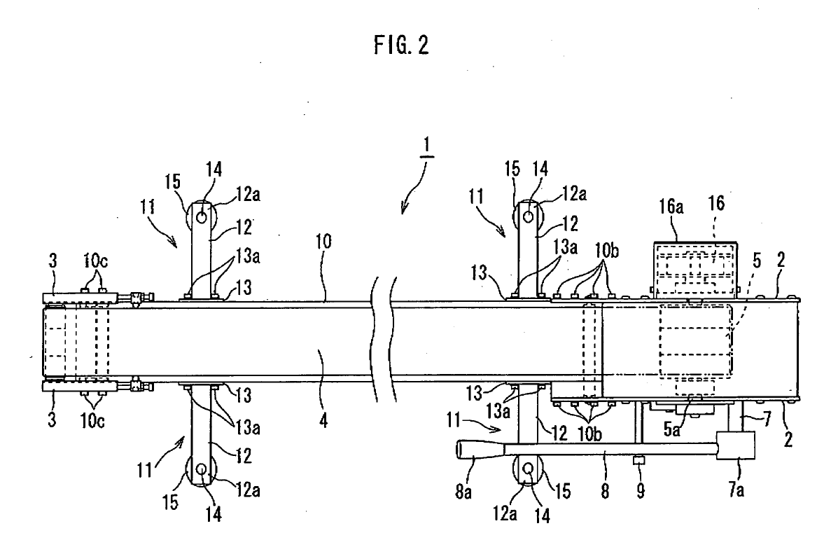

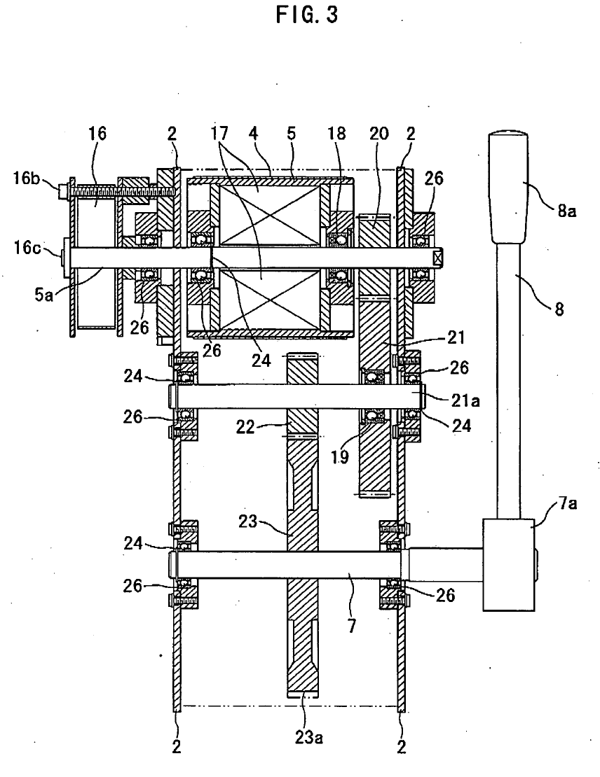

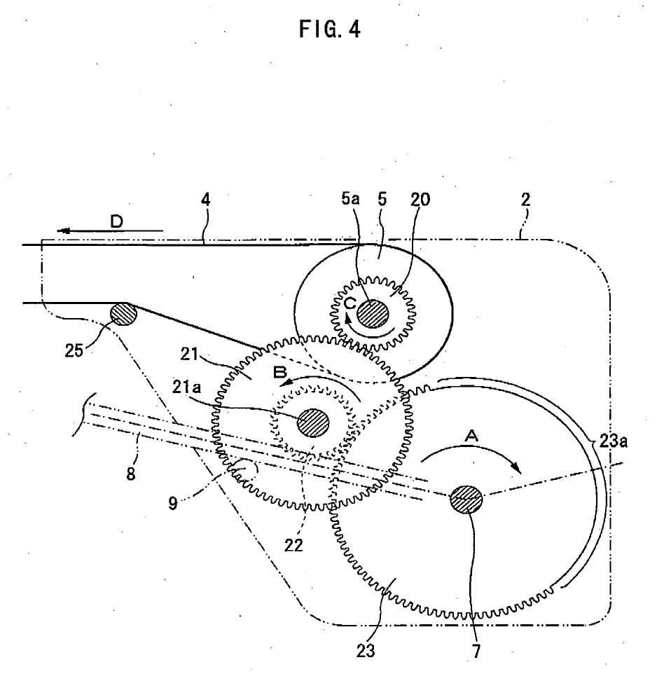

FIG. 1 is a side elevation view showing an overall structure of a spring driven belt conveyor with a middle portion thereof cut away or omitted according to a first embodiment of the invention. FIG. 2 is a top plan view showing an overall structure of the spring driven belt conveyor with a middle portion thereof cut away according to the first embodiment of the invention. FIG. 3 is a vertical sectional view showing a structure of a drive section of the spring driven belt conveyor according to the first embodiment of the invention. FIG. 4 is an enlarged left side elevation view showing the drive section of the spring driven belt conveyor according to the first embodiment of the invention.

Referring to FIG. 1, the first embodiment of the spring driven belt conveyor 1 is constructed with a basic framework. The basic framework is composed of a drive side frame 2, a driven side frame 3, an aluminum plate 10 and two pairs of support legs 11. The drive side frame 2 is composed of two coated steel plates assembled with a not-shown aluminum rod held therebetween. The drive side frame 2 constitutes one of a pair of frames. The driven side frame 3 is composed of two coated steel plates that are spaced apart and opposed to the drive side frame 2. The driven side frame 3 constitutes another of a pair of frames. The aluminum plate 10 as a support has its opposite ends fixed on the pair of the frames 2 and 3. Each pair of the supporting legs 11 is attached on side surfaces of the aluminum plate 10 near the pair of the frames 2 and 3, respectively. The far side supporting leg 11 is not shown in the FIG. 1 due to overlap with the front side supporting leg 11.

As shown in FIG. 2, a drive shaft 5a is horizontally and axially supported on the drive side frame 2. A driving roller 5 is fixed to the drive side frame 2 so as to rotate integrally therewith. In the same way, a driven shaft 6a is horizontally and axially supported on the driven side frame 3. A driven roller 6 is fixed to the driven side frame 3 so as to rotate integrally therewith. An endless conveyor belt 4 is held or stretched between the driving roller 5 and the driven roller 6. An input shaft 7 is horizontally and axially supported on the drive side frame 2. A rotating speed increasing mechanism described later is provided between the drive shaft 5a and the input shaft 7 in the drive side frame 2. An input lever 8 is fixed on the input shaft 7 via a rotation ring 7a. A spiral spring 16 (not shown in FIG. 1) is mounted on the drive shaft 5a at a far side of the drive side frame 2 as shown in FIG. 2. The spiral spring 16 is wound up by turning the input lever 8.

The input lever 8 is in contact with a starting-point bar 9 in FIG. 1. The spiral spring 16 is in its most loose or unstrained state when the input lever 8 is located at such contact position. If a worker holds a grip 8a at a leading end of the input lever 8 and rotates the input lever 8 one hundred and fifty degrees in a right-handed a clockwise direction from such starting point as shown by an imaginary line in FIG. 1, the drive shaft 5a makes about three and a half rotations by an operation of the rotating speed increasing mechanism. Thereby, the spiral spring 16 is also wound up about three and a half rotations so as to store an elastic potential energy at a maximum.

The aluminum plate 10 as the support is wider than the conveyor belt 4. Then, the side surfaces of the aluminum plate 10 are protruded respectively to the front side and the far side from the conveyor belt 4 as shown in FIG. 2. Thus, the supporting legs 11 can be directly attached to the side surfaces of the aluminum plate 10. Still, a width of the aluminum plate 10 is too narrow to maintain stability of the supporting legs 11 which is vertically fixed to the aluminum plate 10. Therefore, each of the supporting legs 11 has a pair of fixing plates 13 that is secured on to a pair of grooves 10a each formed along a center of the side surface of the aluminum plate 10 by fixing bolts 13. Moreover, as shown in FIG. 2, each of the supporting legs 11 has a pair of leg pieces 12 provided at lower ends of the fixing plates 13 so as to be slanted and spread outward from a plane perpendicular to a page sheet of FIG. 1, namely, from the side surfaces of the aluminum plate 10 or side surfaces of the fixing plates 13. Furthermore, lower ends 12a of the leg pieces 12 are respectively bent horizontally. In addition, bottom shafts 14 and rubber feet 15 are fixed on the lower ends 12a of the leg pieces 12 by nuts.

Thus, as shown in the top plan view of FIG. 2, the supporting legs 11 are spread right and left from the side surfaces of the aluminum plate 10 so as to be contacted with a ground surface. Thereby, the supporting legs 11 maintain enough stability to support the conveyor belt 4 at a given height. The aluminum plate 10 as the support is clamped and fixed to each of right and left sides of the drive side frame 2 by screwing four fixing bolts 10b. Thus, eight fixing bolts 10b are used. The aluminum plate 10 is also clamped and fixed to each of right and left sides of the driven side frame 3 by screwing two fixing bolts 10c. Thus, four fixing bolts 10c are used. As described before, the spiral spring 16 is housed in a spring box 16a while attached to the drive shaft 5a at the far side of the drive side frame 2.

Next, the rotating speed increasing mechanism is described referring to FIG. 3. The spring box 16a is not shown in FIG. 3.

As shown in FIG. 3, between the two plated steel sheets of the drive side frame 2, the drive shaft 5a is axially supported in a horizontal manner on the drive side frame 2 by two ball bearings 26. The drive roller 5 is mounted on the drive shaft 5a via a one-way clutch 18 and the ball bearings 26 so as to rotate integrally with the drive shaft 5a. A weight 17 is attached along an entire circumference in the drive roller 5 so as to increase inertia. The conveyor belt 4 is wound around an outer circumference of the drive roller 5. The spiral spring 16 is fitted on a part of the drive shaft 5a that is protruded from the drive side frame 2. A center end of the spiral spring 16 is fixed on the drive shaft 5a by a spring fixing bolt 16c. An outer circumferential end of the spiral spring 16 is fixed on the drive side frame 2 by a spring fixing bolt 16b.

A small diameter gear 20 is integrally fixed to an opposite side of the drive shaft 5a. This small gear 20 meshes with a large diameter gear 21. The large gear 21 is fitted on a rotary shaft 21a through a one-way clutch 19. The rotary shaft 21a is horizontally supported on the drive side frame 2 with its opposite ends axially held by the ball bearings 26. A small diameter gear 22 is integrally fixed near a center of the rotary shaft 21a. The small gear 22 meshes with a large diameter gear 23. The large gear 23 is integrally fixed to the input shaft 7. The input shaft 7 is supported horizontally on the drive side frame 2 with its opposite ends held by the ball bearings 26. The gear 23 has a toothless part 23a over about two fifths of its outer circumference. Retaining rings 24 are fitted respectively in required parts of the drive shaft 5a, the rotary shaft 21a and the input shaft 7 each supported by the ball bearings 26.

In the first embodiment of the spring driven belt conveyor 1, the gear 20 has thirty teeth, while the gear 21 has seventy-five teeth. The gear 22 has thirty teeth, while the gear 23 is to have one-hundred teeth if it has the teeth successively on the entire circumference. When the input lever 8 is rotated one hundred fifty degrees, a number of rotations of the drive shaft 5a is about 3.5 (three and a half) rotations as follows: (150 deg./360 deg.)*(100/30)×(75/30)≈3.5. Consequently the spiral spring 16 is wound up by about 3.5 rotations. In case a length of the spiral spring 16 is two meters when extended or stretched, the spiral spring 16 is stored with a maximum elastic potential energy.

A number of the teeth of the gear 23 determines a stored energy of the spiral spring 16 by its meshing operation in the first embodiment. Accordingly, the number naturally determines a moving distance of the conveyor belt 4, i.e. a conveying distance. Moreover, the gear 22 and the gear 23 are disengaged rapidly, so that the energy stored in the spiral spring 16 can be output at a burst with a resultant high efficiency. In the first embodiment, if the input lever 8 is rotated 150 degrees from the original position shown in FIG. 1, the toothless part 23a of the gear 23 reaches a meshed position of the gear 22 and the gear 23. Consequently, the gear 22 runs idle in a reverse direction so as to release the spiral spring 16. Therefore, there is no problem that the spiral spring 16 is wound too much and damaged.

The one-way clutch 18 is fitted such that it does not transmit rotation to the drive roller 5 when the drive shaft 5a is rotated in a direction to wind up the spiral spring 16, while permitting the drive roller 5 to be rotated integrally when the drive shaft 5a is rotated in a direction to release the spiral spring 16. On the other hand, the one-way clutch 19 is fitted such that it transmits rotation to the gear 21 when the rotary shaft 21a is rotated in a direction to wind up the spiral spring 16, while running idle without transmitting rotation to the rotary shaft 21a when the gear 21 is rotated in a direction to release the spiral spring 16.

A running mechanism of the conveyor belt 4 in the spring driven belt conveyor 1 having such structure is described referring to FIG. 3 and FIG. 4.

When an operator holds the grip 8a at the leading end of the input lever 8 shown in FIG. 3 and turns the input lever 8 in a right direction or a clockwise direction when seen from the right side in FIG. 3, namely, to a far side in the sheet of FIG. 3, the input shaft 7 is rotated via the rotation ring 7a. Then, the gear 23 fixed on the input shaft 7 is rotated integrally. Accordingly, the gear 22 meshed with the gear 23 is integrally rotated with the rotary shaft 21a on which the gear 23 is fixed. In this case, the rotary shaft 21a is rotated in the direction to wind up the spiral spring 16. Then, the one-way clutch 19 transmits the rotation to the gear 21, so that the gear 12 is integrally rotated. Moreover, the gear 20 meshed with the gear 21 is integrally rotated with the drive shaft 5a on which the gear 20 is fixed. Then, the gear 20 begins winding up the spiral spring 16 that is attached to the other end. However, the one-way clutch 18 does not transmit the rotation to the drive roller 5. Consequently, the conveyor belt 4 never moves in a reverse direction. As a result, it is possible to wind up the spiral spring 16 with a small force.

As described above, as the gear 23 is rotated in an arrow direction A as shown in FIG. 4, the gears 22 and 21 are rotated in an arrow direction B, while the gear 20 and the drive shaft 5a being rotated in an arrow direction C. Thus, the spiral spring 16 is wound up tightly little by little so as to store the elastic energy. Then, when a rotation angle in the arrow direction A reaches about 150 degrees, an end of the toothless part 23a of the gear 23 arrives a meshing part with the gear 22. Thereby, the gear 23 becomes disengaged with the gear 22. Consequently, the rotary shaft 21a and the drive shaft 5a are respectively rotated in a reverse direction to each of the arrow directions B and C by a releasing energy of the spiral spring 16. As a result, the drive roller 5 is rotated in the left-hand direction or the counterclockwise direction so as to make the conveyor belt 4 run in the arrow direction D.

At this time, the one-way clutch 18 shown in FIG. 3 transmits the rotation of the drive shaft 5a to the drive roller 5 so as to rotate the drive roller 5. On the other hand, the one-way clutch 19 does not transmit the rotation of the gear 21 to the rotary shaft 21a, so that the gear 21 runs idle. Accordingly, a torque of the drive shaft 5a is only wasted for rotation of the gears 20 and 21 in addition to the rotation the drive roller 5. Therefore, the elastic energy stored in the spiral spring 16 is used efficiently for driving the conveyor belt 4. Moreover, since the weight 17 is fitted inside the drive roller 5, the drive roller 5 is rotated several times more than the number of rotations by the releasing power of the spiral spring 16 by an inertia force of the weight 17. Consequently, the conveyor belt 4 can be traveled at a longer distance.

As described above, in the spring driven belt conveyor 1 according to the first embodiment, the spiral spring 16 is manually wound up only when needed. Then, the conveyor belt 4 can be fed by winding up the spiral spring 16 with a little force without driving the conveyor belt 4 in the reverse direction. Thus, it is possible to save an energy to a large extent without using any electric power. Moreover, there is no possibility that the spiral spring 16 is wound up too much and damaged.

If the input lever 8 shown in FIG. 4 is rotated in the arrow direction A by a slight angle and returned in a reverse direction by a desired angle, the conveyor belt 4 can be moved little by little or inched. Still, even if the input lever 8 is returned in the reverse direction and stopped, the gear 21 runs idle by operation of the one-way clutch 19 provided on the gear 21. Therefore, the conveyor belt 4 does not stop at such position but continues running until the spiral spring 16 is completely released and the inertia force of the drive roller 5 disappears.

Accordingly, the gear 21 is preferably fixed directly on the rotary shaft 21a without the one-way clutch 19 interposed therebetween as in the first embodiment. In such case, the conveyor belt 4 can be driven by a slight distance or inched more flexibly. Then, if the input lever 8 is rotated in the arrow direction A by a desired angle within an range of about 150 degrees and returned in the reverse direction and stopped thereat, the conveyor belt 4 stops at the same position. Thus, it is possible to convey a workpiece to a desired position by returning and stopping the input lever 8 while monitoring a position of the workpiece on the conveyor belt 4.

### Second Embodiment

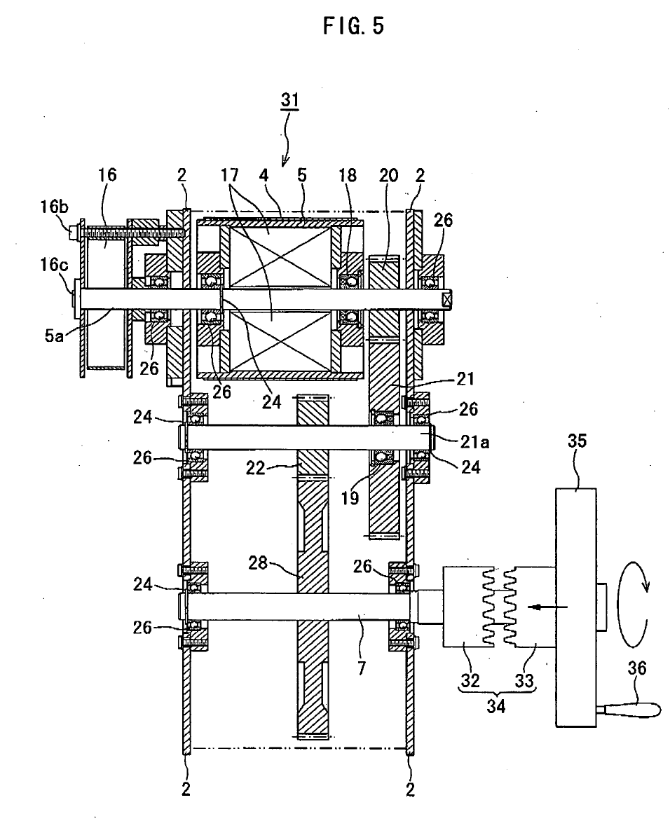

A second embodiment of the invention is described referring to FIG. 5. FIG. 5 is a vertical sectional view showing a structure of a drive section of a spring driven belt conveyor according to a second embodiment of the invention.

As shown in FIG. 5, a spring driven belt conveyor 31 according to the second embodiment has main components similar to those of the first embodiment of the spring driven belt conveyor 1. Therefore, the same reference numerals or characters will be affixed to the same components, elements or parts in order to omit their description. The second embodiment is different from the first embodiment in the following points. First, a gear 28 having teeth over its entire circumference is fixed on the input shaft 7, while the gear 23 having the toothless part 23a being fixed on the input shaft 7 in the first embodiment. Second, a rotary handle disc 35 is provided at the end of the input shaft 7 via a clutch mechanism 34, while the input lever 8 is provided thereat in the first embodiment.

The clutch mechanism 34 is composed of a cylindrical gear 32 and a cylindrical gear 33. The gear 34 is fixed at the end of the input shaft 7. The rotary handle disc 35 is axially supported on the input shaft 7 so as to rotate and move forward and backward. The gear 33 is fixed on the rotary handle disc 35. In a state shown in FIG. 5, the rotary handle disc 35 is in a backward position so that the clutch mechanism 34 is in a released position. If the rotary handle disc 35 is moved forward in an arrow direction from the above position, the cylindrical gear 32 and the cylindrical gear 33 are meshed with each other so that the clutch mechanism 34 is in an engaged state. Then, if an operator holds a handle 36 to turn the rotary handle disc 35 in a right-hand direction or a clockwise direction, the input shaft 7 is rotated. Thus, a torque is transmitted to the drive shaft 5a in the same way as the first embodiment, so that the spiral spring 16 is wound up.

In the second embodiment, the gear 28 fixed on the input shaft 7 has the teeth over the entire circumference. Therefore, when the input shaft 7 turns up to about 150 degrees that are a winding-up limit of the spiral spring 16, the gear 22 never runs idle automatically or releases the spiral spring 16 in contrast with the first embodiment. Consequently, there is a need for providing a measure for preventing the spiral spring 16 from being wound up over the winding-up limit and being damaged. For such purpose, a rotation range may be clearly shown or specified at an outside of the drive side frame 2, for example. Alternatively, a stopper may be disposed in relation to the handle 36.

After the clutch mechanism 34 is engaged and the rotary handle disc 35 is turned to a desired angle within a rotation range by holding the handle 36, the rotary handle disc 35 is held with both hands so as to move backward the rotary handle disc 35 and the cylindrical gear 33. Thereby, the clutch mechanism 34 becomes in the released state. Then, the input shaft 7, the gear 28, the gear 22, the rotary shaft 21a, the gear 21, the gear 20 and the drive shaft 5a are rotated in a reverse direction by the elastic force stored in the spiral spring 16. Accordingly, the drive roller 5 is rotated integrally with the drive shaft 5a by the operation of the one-way clutch 18. Consequently, the conveyor belt 4 has its upper part fed out in a predetermined direction or a front direction in FIG. 5 and its lower part fed into the drive roller 5. Thus, the conveyor belt 4 runs.

At this time, the one-way clutch 19 does not transmit the rotation of the gear 21 to the rotary shaft 21a, so that the gear 21 runs idle. Accordingly, a torque of the drive shaft 5a is only wasted for rotation of the gears 20 and 21 in addition to the rotation of the drive roller 5. Therefore, the elastic energy stored in the spiral spring 16 is used efficiently for driving the conveyor belt 4. Moreover, since the weight 17 is fitted inside the drive roller 5, the drive roller 5 is rotated several times more than the number of rotations by the releasing power of the spiral spring 16 by an inertia force of the weight 17. Consequently, the conveyor belt 4 can be traveled at a longer distance.

As described above, in the spring driven belt conveyor 31 according to the second embodiment, the spiral spring 16 is manually wound up only when needed. Then, the conveyor belt 4 can be fed by winding up the spiral spring 16 with a little force without driving the conveyor belt 4 in the reverse direction. Thus, it is possible to save an energy to a large extent without using any electric power. Moreover, the spring driven belt conveyor 31 can be installed at a small space since it uses the rotary handle disc 35 in place of the long input lever 8.

### Third Embodiment

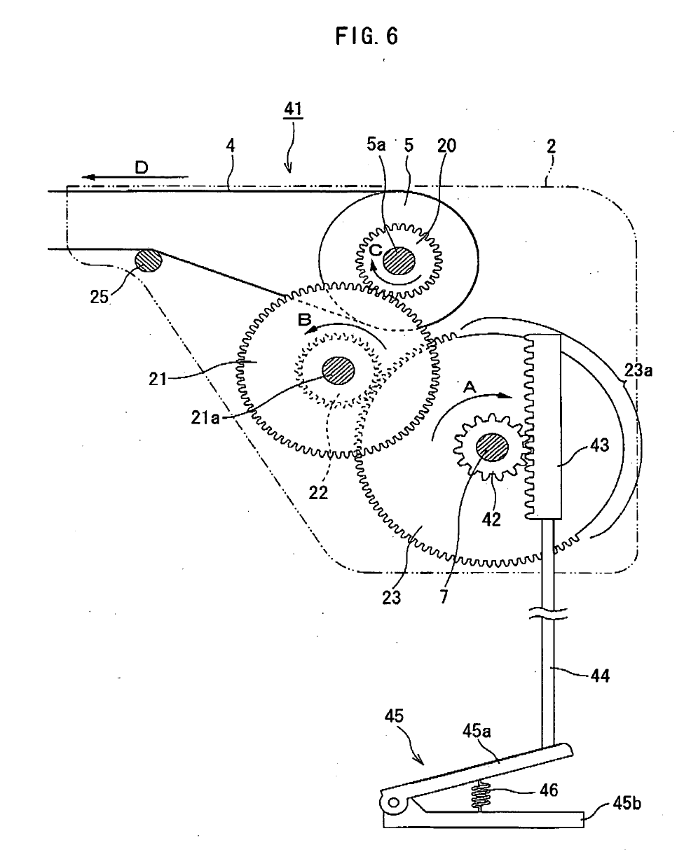

A third embodiment of the invention is described referring to FIG. 6.

FIG. 6 is an enlarged left side elevation view showing a drive section of a spring driven belt conveyor according to a third embodiment of the invention. Most of components of a spring driven belt conveyor according to the third embodiment are similar to those of the first embodiment and the second embodiment. Therefore, the same reference numerals or characters will be affixed to the same components, elements or parts in order to omit their description.

As shown in FIG. 6, in the third embodiment of the spring driven belt conveyor 41, the input shaft 7 is rotated not by hand power but by foot power in contrast with the first and the second embodiments. Specifically, while the input lever 8 is fixed on the input shaft 7 in the first and the second embodiment, a pinion gear 42 is fixed on the input shaft 7 so as to rotate integrally. A rack gear 43 meshing with the pinion gear 42 is fitted so as to move vertically. An elongate transmission shaft 44 is fixed vertically on a lower end of the rack gear 43 so as to reach a position near a floor surface. A lower end of the transmission shaft 44 is fitted in a rotatable manner on a step plate 45a of a step pedal 45. The step pedal 45 is disposed on the floor surface.

A compression spring 46 is attached between the step plate 45a and a bottom plate 45b of the step pedal 45. The compression spring 46 keeps its original state such that the rack gear 43, the pinion gear 42 and the gear 23 return to their original positions shown in FIG. 6, when no force is applied to the step plate 45a. If an operator presses the step plate 45a by his or her foot from the above state, the rack gear 43 is vertically lowered together with the transmission shaft 44. Then, the pinion 42 is rotated in an arrow direction A. Thus, the input shaft 7 and the gear 23 are rotated integrally so as to turn the rotary shaft 21a in an arrow direction B and the drive shaft 5a in an arrow direction C. Consequently, the spiral spring 16 fitted on the drive shaft 5a is wound up.

In the third embodiment, a gear ratio of the pinion gear 42 and the rack gear 43 is set such that the input shaft 7 is rotated about 150 degrees when the rack gear 43 is lowered about 10 cm. Then, if an operator presses the step plate 45a by about 10 cm, one end of the toothless part 23a of the gear 23 arrives at the meshing position of the gear 23 and the gear 22. Thereby, the gear 22 runs idle so that the spiral spring 16 is released. Consequently, the drive shaft 5a and the rotary shaft 21a are rotated in reverse directions to arrow directions, respectively. Thus, the drive roller 5 is rotated integrally with the drive shaft 5a so as to feed out and drive the conveyor belt 4 in an arrow direction D. If the operator releases his or her pressing force after pushing the step plate 45a within the range of about 10 cm, the step plate 45a returns a little by a repulsive force of the compression spring 46. Then, the rack gear 43 is raised a little. Thus, it is possible to rotate the input shaft 7, the rotary shaft 21a and the drive shaft 5a in the reverse directions to the arrow directions, respectively, thereby inching the conveyor belt 4.

As described above, in the spring driven belt conveyor 41 according to the third embodiment, the spiral spring 16 is wound up only when needed. Then, the conveyor belt can be driven more safely by use of the elastic force stored in the spiral spring 16. Thus, it is possible to save an energy to a large extent without using any electric power. Moreover, since the operator is free to use both hands, he or she can perform another work at the same time, while driving the spring driven belt conveyor 41.

### Fourth Embodiment

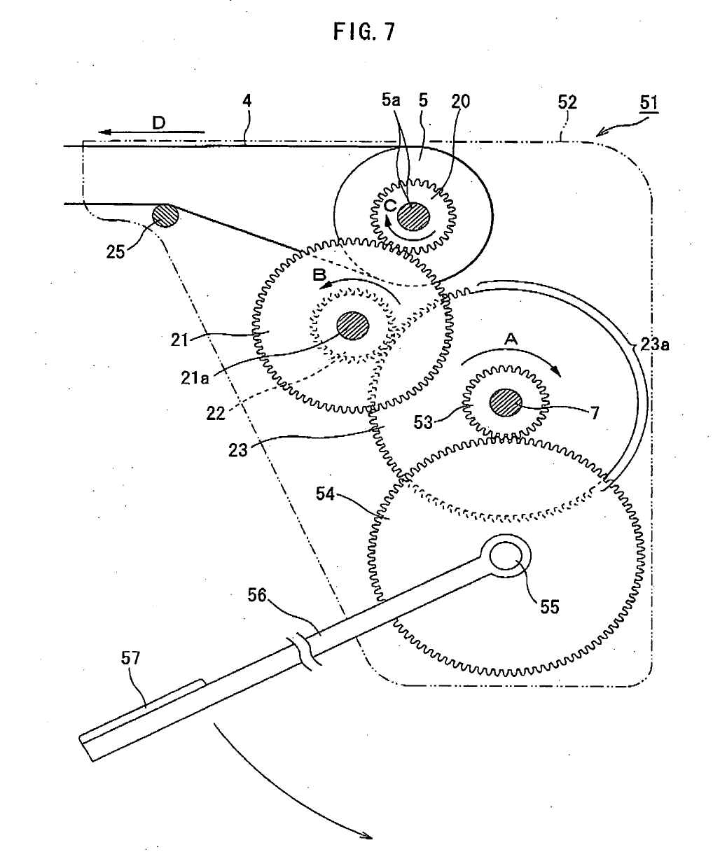

A fourth embodiment of the invention is described referring to FIG. 7. FIG. 7 is an enlarged left side elevation view showing a drive section of a spring driven belt conveyor according to a fourth embodiment of the invention. Most of components of a spring driven belt conveyor according to the fourth embodiment are similar to those of the first to third embodiments. Therefore, the same reference numerals or characters will be affixed to the same components, elements or parts in order to omit their description.

As shown in FIG. 7, in the fourth embodiment of the spring driven belt conveyor 51, the input shaft 7 is rotated not by hand power but by foot power, too. However, a step pedal 57 is mounted on a leading end of an input lever 56 in contrast with the third embodiment. It is almost impossible to rotate the input lever 56 by about 150 degrees only by foot press. Therefore, a small diameter gear 53 having thirty teeth is fixed on the input shaft 7. A large diameter gear 54 having one hundred teeth is fixed on a second input shaft 55. Then, the large gear 54 is meshed with the small gear 53. The input lever 56 is secured on the second input shaft 55. Thus, the belt conveyor is structured such that, if the input lever 56 is turned about 45 degrees, the input shaft 7 is rotated about 150 degrees. Accordingly, a drive frame 52 as one of a pair of frames becomes large according to increase of a size of a rotating speed increasing mechanism.

With the spring driven belt conveyor 51 having such structure, if the operator presses the step pedal 57 by his or her foot, the input lever 56 is turned in an arrow direction. Then, the second input shaft 55 and the gear 54 are rotated integrally so as to make the meshed gear 53 rotate in the arrow direction A. Thereby, the input shaft 7 and the gear 23 are integrally rotated so as to turn the rotary shaft 21a in an arrow direction B and the drive shaft 5a in an arrow direction C. Consequently, the spiral spring 16 fitted to the drive shaft 5a is wound up. If the operator turns the step pedal 57 by about 45 degrees, one end of the toothless part 23a of the gear 23 arrives at a meshing position of the gear 23 and the gear 22. Then, the gear 22 runs idle. Therefore, the spiral spring 16 is released so that the drive shaft 5a and the rotary shaft 21a are rotated in the reverse directions to the arrow directions, respectively. Consequently, the drive roller 5 is rotated integrally with the drive shaft 5a so as to feed out and drive the conveyor belt 4 in an arrow direction D.

As described above, in the spring driven belt conveyor 51 according to the fourth embodiment, the spiral spring 16 is wound up only when needed. Then, the conveyor belt can be driven more safely by use of the elastic force stored in the spiral spring 16. Thus, it is possible to save an energy to a large extent without using any electric power. Moreover, since the operator is free to use both hands, he or she can perform another work at the same time, while driving the spring driven belt conveyor 51.

The first embodiment is described on an example in which the gear 23 is made of a fiber reinforced plastic or FRP. However, the gear 23 may be made of a normal steep for gears. To the contrary, the other gears 20, 21 and 22 may be made of FRP. In the second embodiment, the gears 20, 21, 22 and 28 may be made of FRP. In these cases, there is an advantageous effect that the rotating speed increasing mechanism becomes light and a load applied to the supporting legs 11 lessens.

In practicing the invention of the first to the fourth embodiments, the spring driven belt conveyor is not limited to those of each of the above embodiments in the structure, shape, number, material, dimension, connecting relation or the like of the other components or parts.

In embodying the invention of the first to the fourth embodiments, the mechanism may be disposed as follows. Specifically, the spiral spring 16 is wound up within a range of the winding up limit, while the conveyor belt 4 being restrained from movement. Then, the restraint of the conveyor belt 4 is released by a predetermined button operation so as to make the energy of the spiral spring 16 discharged.

Since the inventive belt conveyor uses no electricity, the inventive belt conveyor according to the first to the fourth embodiments is applicable to a watery workplace, for example, a kitchen, a farm workplace under the scorching sun, or carrying in a water tank and carrying out of the water tank in which the conveyor is put in water. In the kitchen, the inventive belt conveyor requires no waterproof wiring for improving electric insulation of an isolation transformer or the like even in case of delivery and receipt between the kitchen and a service room. Consequently, the belt conveyor becomes inexpensive.

When the inventive belt conveyor according to the first to the fourth embodiment is not driven, it does not use energy at all. Therefore, the inventive belt conveyor has a energy saving effect in contrast with the conventional belt conveyor that is always operated continuously.

The inventive belt conveyor according to the first to the fourth embodiments is also applicable to transport between a mixing room and a delivery room of a pharmacy or the like, delivery and receipt between a clean room and an outside, sorting work and transport after sorting in a sorting or grading place of vegetables and fruits, and, as a matter of course, to delivery from labor-intensive workplace in an assembly plant to a main conveyor, assembly and transport of parts in a group unit or the like, transport in a box or case packaged unit or the like.

### Fifth Embodiment

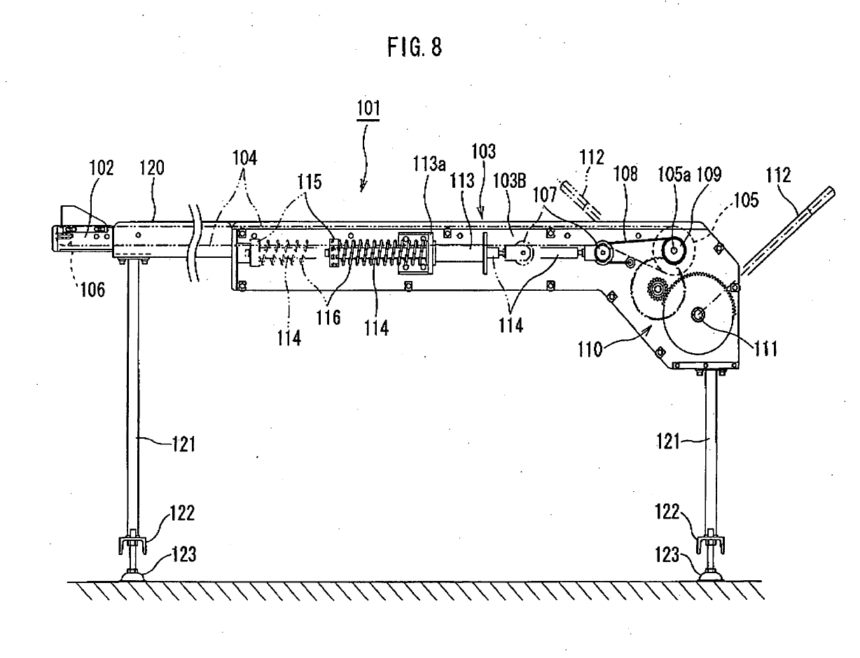

A fifth embodiment of the invention is described hereafter referring to FIG. 8 to FIG. 13.

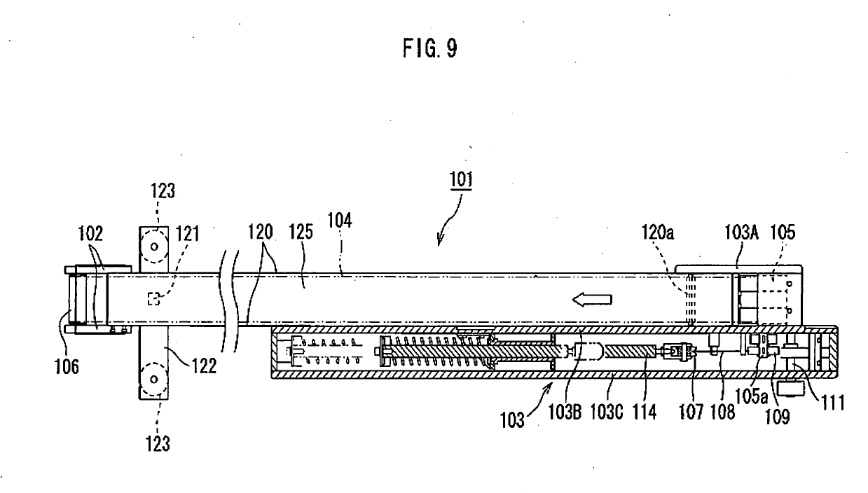

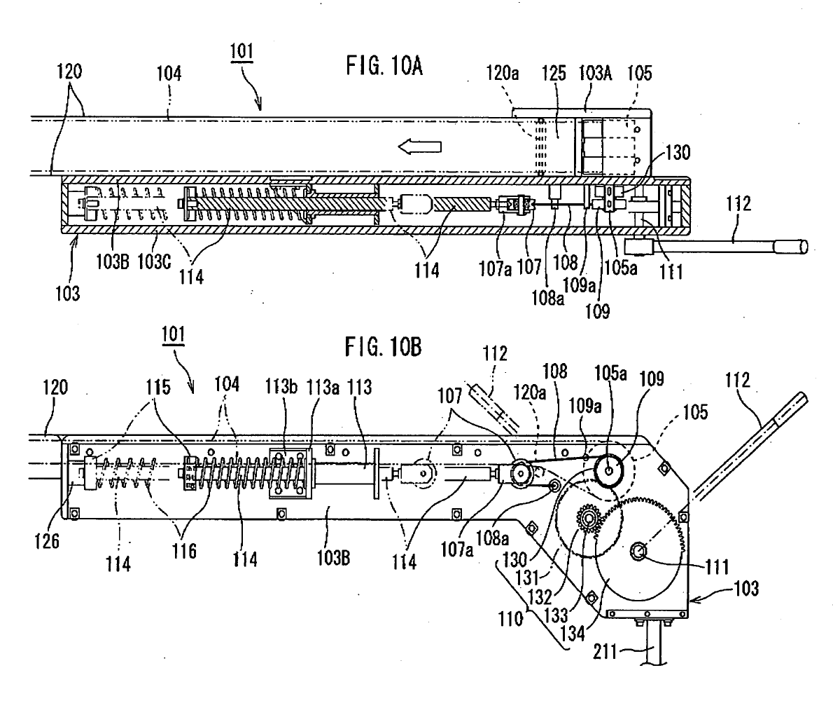

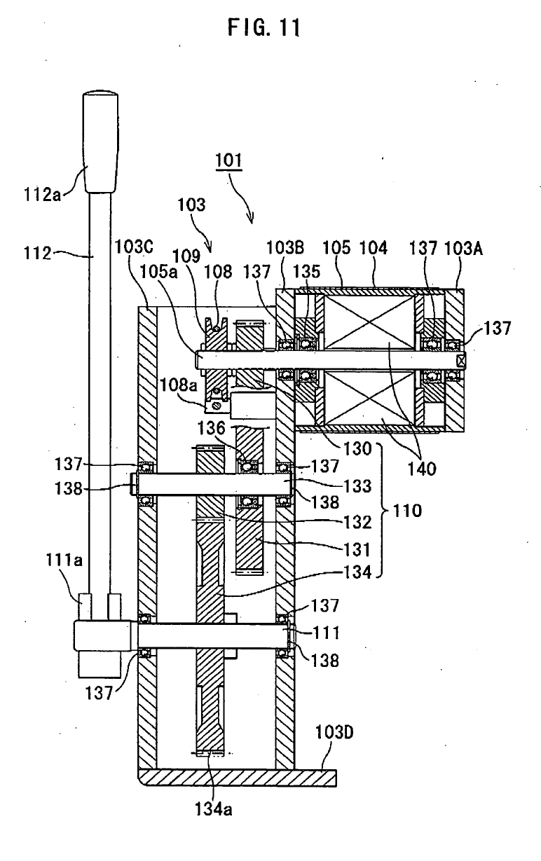

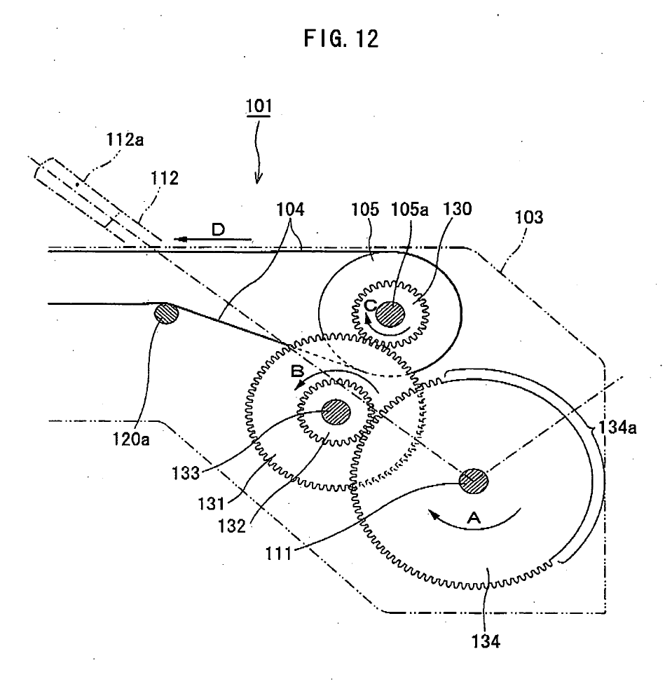

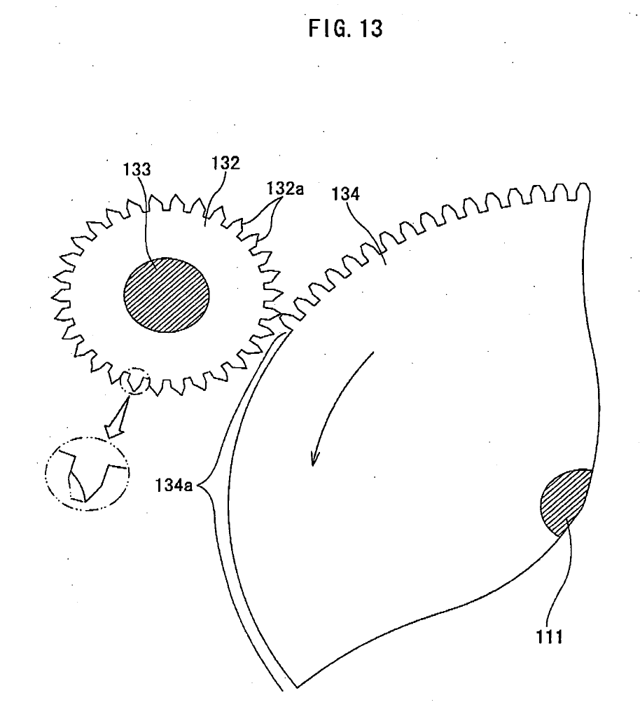

FIG. 8 is a side elevation view showing an overall structure of a belt conveyor with a front side frame plate of a third frame dismounted and with a middle portion thereof cut away according to a fifth embodiment of the invention. FIG. 9 is a top plan view showing an overall structure of the belt conveyor with a middle portion thereof cut away according to the fifth embodiment of the invention. FIG. 10A is a top plan view showing a structure of a drive section of the belt conveyor according to the fifth embodiment of the invention. FIG. 10B is a side elevation view showing the structure of the drive section of the belt conveyor according to the fifth embodiment of the invention. FIG. 11 is a vertical sectional view showing a rotating speed increasing transmission mechanism of the belt conveyor according to the fifth embodiment of the invention. FIG. 12 is a left side elevation view showing the rotating speed increasing transmission mechanism of the belt conveyor according to the fifth embodiment of the invention. FIG. 13 is a partially enlarged left side elevation view showing the rotating speed increasing transmission mechanism of the belt conveyor according to the fifth embodiment of the invention.

Referring to FIG. 8, the fifth embodiment of the belt conveyor 101 is constructed mainly with the following components. Specifically, a driven side frame 102 as a second frame is composed of a pair of frame plates assembled with a support (not shown) held therebetween. A drive side frame (not shown) as a first frame is placed opposite to and spaced apart from the driven side frame 102, while sharing a middle frame plate with a third frame 103. A drive shaft 105a is axially supported on the drive side frame. A drive roller 105 is attached to the drive shaft 105a so as to rotate integrally therewith. A driven shaft (not shown) is axially supported on the driven side frame 102. A driven roller 106 is attached to the driven shaft so as to rotate integrally therewith. An endless drivable conveyor belt 104 is held and stretched between the drive roller 105 and the driven roller 106.

As shown in FIG. 9, an aluminum plate 125 as a support has its opposite ends fixed on the pair of the drive side frame (not shown) and the driven side frame 102. A panel 120 of a channel cross-section is protruded to opposite sides of the aluminum plate 125 so as to cover the opposite side surfaces of the conveyor belt 104. The panel 120 is fastened on the aluminum plate 125 by screws entirely between the drive side frame (not shown) and the drive side frame 102. One supporting leg 121 is fitted on a left end of a bottom surface of the channel section panel 120, while two supporting legs 121 being fitted on a right end of the third frame 103, though one of them is not show because it is overlapped. The supporting legs 121 serve to hold the conveyor belt 104 at a required height. Channel members 122 are fixed respective on lower ends of these three supporting legs 121 so as to extend in a direction perpendicular to a sheet plane of FIG. 8 or a horizontal direction in FIG. 9, thereby keeping stability of the supporting legs 121. Support bases 123 are secured on a front side and a far side of the channel member 122, respectively.

A flanged guide 113 is fixed on the middle frame plate 103B of the third frame 103 so as to extend in parallel to the conveyor belt 104. A long rod 114 is fitted into the flanged guide 113 so as to slide in a parallel direction to the conveyor belt without jounce. A spring holder 115 is fixed on a left end of the long rod 114. A coil spring 116 is mounted between a flange 113a of the flanged guide 113 and the spring holder 115 so as to surround the long rod 114. A first pulley 107 is attached to a right end of the long rod 114 so as to rotate. One end of a strong and soft wire 108 is fixed on the middle frame plate 103B of the third frame 103. A second pulley 109 is fixed on the drive shaft 105a, which is protruded inside the third frame 103, so as to rotate integrally therewith. The wire 108 is wound around the first pulley 107 and then wound around the second pulley 109. The wire 108 has another end fixed on the second pulley 109.

An input shaft 111 is axially and horizontally supported on a right end of the third frame 103 in the same manner as the drive shaft 105a, while being separated away from the input shaft 105a. An input lever 112 is fixed on the input shaft 111 so as to rotate integrally therewith. A rotating speed increasing mechanisms 110 is disposed between the input shaft 111 and the drive shaft 105a so as to increase and transmit a rotating speed of the input shaft 111 to the drive shaft 105a.

The belt conveyor 101 according to the fifth embodiment is described more in detail referring to the plan view of FIG. 9. As shown in FIG. 9, an outside frame plate 103A of the first frame is provided at a far side of the middle frame plate 103B of the third frame 103. The drive shaft 105 is supported axially and horizontally between the outside frame plate 103A and the middle frame plate 103B.

The drive roller 105 is attached to the drive shaft 105a so as to rotate integrally therewith. The first frame is composed of the outside frame plate 103A and part of the middle frame plate 103B. The second frame is provided away from and opposite to the first frame. An aluminum plate 125 is held or stretched between the first frame and the second frame 102, while being fixed on the first frame and the second frame 102, respectively.

The endless conveyor belt 104 is held in a stretched manner between the drive roller 105 and the driven roller 106. As described later, if the input lever 112 is operated, the conveyor belt 104 moves at high speed in a white or outline arrow direction so as to carry products or the like. As describer before, the supporting legs 121 are attached to the left end of the bottom surface of the channel shaped panel 120 so as to support the conveyor belt 104 at a required height. Moreover, the channel shaped members 122 are fixed on the lower ends of the supporting legs 121, while the support bases 123 are fixed on the opposite ends of the channel shaped members 122, respectively. Two supporting legs having a similar structure are fixed on a right end of the bottom surface of the third frame 103, though they are eliminated from illustration in FIG. 9.

A drive mechanism of the fifth embodiment of the belt conveyor 101 is described more in detail referring to FIG. 10A and FIG. 10B. As shown in FIG. 10A and FIG. 10B, a bracket 113b is formed integrally with the flange 113a of he flanged guide 113. The bracket 113b is screwed on the middle frame plate 10B by four screws. As shown in FIG. 10A, an auxiliary roller 120a is axially supported between the outside frame plate 103A and the middle frame plate 103B so as to rotate. As shown in FIG. 10B, the auxiliary roller 120a improves more a tension of the conveyor belt 104. Then, the auxiliary roller 120a makes a lower side of the conveyor belt 104 generally parallel to an upper side of the conveyor belt 104 from the auxiliary roller 120a to the driven roller 106, thereby improving an appearance.

The coil spring 116 is changed from a compressed state shown by a solid line to an extended state shown by an imaginary line. Accordingly, the long rod 114 slides at high speed from a position shown by a solid line to a position shown by an imaginary line. Then, a rubber stopper 126 is provided in order to absorb an impact shock given by the spring holder 115 colliding with a left end of the third frame 103 at that time. Moreover, a wire restrainer 109a is fixed near the second pulley 109 so as to prevent the wire 108 wound around the second pulley 109 from being undulated and disengaged from the second pulley 109 when the second pulley 109 is rotated at high speed at this time. The wire restrainer 109a has a deep groove cut at its end surface. The wire 108 passes through the groove. One end of the wire 108 is securely fixed on a wire stopper 108a. The wire 108 is wound around the first pulley 107 and then passed through the deep groove of the wire restrainer 109a and wound around the second pulley 109. Thereafter, the other end of the wire 108 is securely fixed on the second pulley 109.

A small diameter gear 130 is fixed at a far side of the second pulley 109 that is secured on the drive shaft 105a protruded inside the third frame 103. The gear 130 rotates integrally with the drive shaft 105a. A large diameter gear 131 is meshed with the gear 130. The gear 131 rotates with integrally with a rotary shaft 133 axially supported on the third frame 103. A small diameter gear 132 is fixed on the rotary shaft 133 so as to rotate integrally therewith. A large diameter gear 134 is meshed with the gear 132. The gear 134 has teeth only over about a half circumference. The gear 134 is fixed on the input shaft 111 so as to rotate integrally therewith. When the input shaft 111 rotates, the gear 134, the gear 132, the gear 133, the gear 131 and the gear 130 increase a rotating speed so as to transmit the rotation to the drive shaft 105a. Accordingly, the gear 130, the gear 131, the gear 132, the gear 133 and the gear 134 constitute the rotating speed increasing mechanism 110.

The rotating speed increasing mechanism 110 is described more in detail referring to FIG. 11. As shown in FIG. 11, between the two plated steel sheets or the frame plates 103A and 103B constituting the first frame, the drive shaft 105a is axially supported in a horizontal manner on the two plated steel sheets or the frame plates 103A and 103B by two ball bearings 137. The drive roller 105 is mounted the drive shaft 105a via a one-way clutch 135 and the ball bearings 137 so as to rotate integrally with the drive shaft 105a. A weight 140 is attached along an entire circumference in the drive roller 105 so as to increase inertia. The conveyor belt 104 is wound around an outer circumference of the drive roller 105. The small diameter gear 130 is integrally fixed on a portion of the drive shaft 105a that is protruded from the middle frame plate 103B. The second pulley 109 for winding up the wire 108 is secured on an outside of the protruded portion of the drive shaft 105a. The rotary shaft 133 has its opposite ends supported axially on the third frame 103 via the ball bearings 137. The large diameter gear 131 meshing with the gear 130 is mounted on the rotary shaft 133 via a one-way clutch 136.

The small diameter gear 132 is fixed integrally at an axial center side of the rotary shaft 133. The input shaft 111 has its opposite ends supported axially and horizontally on the third frame 103 via the ball bearings 137. The large diameter gear 134 meshing with the gear 132 is integrally fixed on the input shaft 111. The gear 134 has a toothless portion 134a over about two fifth of its outer circumference. Retainer rings 138 are fitted in necessary parts of the drive shaft 105a, the rotary shaft 133 and the input shaft 111 each of which is supported by the ball bearings 137.

A number of teeth of the gear 134 of the belt conveyor 101 according to the fifth embodiment determines an energy stored in the coil spring 116 by its meshing operation. A moving distance of the conveyor belt 104, that is, a conveying distance is naturally determined in accordance with such number. Since the gear 132 and the gear 134 are disengaged rapidly, so that the energy stored in the coil spring 116 can be output at a burst with a resulting high efficiency. In the fifth embodiment, if the input lever 112 is rotated a predetermined angle from an original position shown by an imaginary line in FIG. 8 and FIG. 10B, the toothless part 134a of the gear 134 reaches a meshed position of the gear 132 and the gear 134. Consequently, the gear 132 runs idle in a reverse direction so as to release the coil spring 116. Therefore, there is no problem that the coil spring 116 is compressed too much and damaged.

The one-way clutch 135 is fitted such that it does not transmit rotation to the drive roller 105 when the drive shaft 105a is rotated in a direction to compress the coil spring 116, while permitting the drive roller 105 to be rotated integrally when the drive shaft 105a is rotated in a direction to release the coil spring 116. On the other hand, the one-way clutch 136 is fitted such that it transmits rotation to the gear 131 when the rotary shaft 133 is rotated in a direction to compress the coil spring 116, while running idle without transmitting rotation to the rotary shaft 133 when the gear 131 is rotated in a direction to release the coil spring 116.

A running mechanism of the conveyor belt 104 in the belt conveyor 101 having such structure is described referring to FIG. 8 to FIG. 12. When an operator holds a grip 112a at the leading end of the input lever 112 shown in FIG. 11 and turns the input lever 112 in a right direction or a clockwise direction in FIG. 8, namely, the input shaft 111 is rotated via the rotation ring 111a shown in FIG. 11. Then, the gear 134 fixed on the input shaft 111 is rotated integrally. Accordingly, the gear 132 meshed with the gear 134 is integrally rotated with the rotary shaft 133 on which the gear 132 is fixed. In this case, the rotary shaft 133 is rotated in the direction to compress the coil spring 116. Then, the one-way clutch 136 transmits the rotation to the gear 131, so that the gear 131 is integrally rotated.

Moreover, the gear 130 meshed with the gear 131 is integrally rotated with the drive shaft 105a on which the gear 130 is fixed. Then, the second pulley 109 fixed on the drive shaft 105a is rotated in a direction to wind up the wire 108. Thereby, as shown in FIG. 8, the first pulley 107 at the original position shown by the imaginary line is pulled to the right side as the wire 108 is wound up. Consequently, the long rod 114 slides from the original position shown by the imaginary line to the position shown by the solid line, so that the coil spring 116 in a released state is compressed as shown by a solid line. At this time, the one-way clutch 135 shown in FIG. 11 does not transmit rotation to the drive roller 105, so that the conveyor belt 104 never runs in a reverse direction. As a result, it is possible to compress the coil spring 116 with a small force.

As described above, as the gear 134 is rotated in an arrow direction A as shown in FIG. 12, the gears 132 and 131 are rotated in an arrow direction B, while the gear 130 and the drive shaft 105a being rotated in an arrow direction C. Thus, the coil spring 116 is compressed strongly little by little so as to store the elastic energy. Then, when a rotation angle in the arrow direction A reaches a predetermined angle, an end of the toothless part 134a of the gear 134 arrives a meshing part with the gear 132. Thereby, the gear 134 becomes disengaged with the gear 132. Consequently, the rotary shaft 133 and the drive shaft 105a are respectively rotated in a reverse direction to each of the arrow directions B and C by an extending energy of the coil spring 116. As a result, the drive roller 105 is rotated in the left-hand direction or the counterclockwise direction so as to make the conveyor belt 104 run in the arrow direction D.

At this time, the one-way clutch 135 shown in FIG. 11 transmits the rotation of the drive shaft 105a to the drive roller 105 so as to rotate the drive roller 105. On the other hand, the one-way clutch 136 does not transmit the rotation of the gear 131 to the rotary shaft 133, so that the gear 131 runs idle. Accordingly, a torque of the drive shaft 105a is only wasted for rotation of the gears 130 and 131 in addition to the rotation the drive roller 105. Therefore, the elastic energy stored in the coil spring 116 is used efficiently for driving the conveyor belt 104. Moreover, since the weight 140 is fitted inside the drive roller 105, the drive roller 105 is rotated several times more than the number of rotations by the releasing power of the coil spring 116 by an inertia force of the weight 140. Consequently, the conveyor belt 104 can be traveled at a longer distance.

In order to drive the conveyor belt 104 in a next operation, the gear 134 fixed on the input shaft 111 is rotated in an arrow direction to make a toothed portion of the gear 134 meshed with the engaging gear 132 again as shown in FIG. 13. Then, the input lever 112 is rotated to the original position. Thereafter, the input lever 112 needs to be rotated more so as to compress the coil spring 116 again. However, an end tooth next to the toothless portion 134a of the gear 134 fixed on the input shaft 111 is not always meshed successfully again with a tooth of the meshing gear 132. There arise some cases in which both top parts of the teeth of the gears 132 and 134 collide with each other and the gears 132 and 134 are not meshed well.

Then, in the fifth embodiment, as shown in FIG. 13, all the teeth of the meshing gear 132 are cut off over a part 132a corresponding to a locus drawn by a tooth edge of the end tooth of the gear 134. Thus, the end tooth of the gear 134 is meshed with the tooth of the meshing gear 132 100% successfully. Thereby, even when both the gear 132 and 134 come to a position where the top parts of their teeth collide with each other, the end tooth of the gear 134 dodges the tooth of the gear 132 without colliding therewith, since the tooth edge 132a of the meshing gear 132 is cut off. Then, the end tooth of the gear 134 comes into contact with a non-cut side of a next tooth of the gear 132 so that both the gear 132 and 134 are meshed 100% successfully.

As described above, in the belt conveyor 101 according to the fifth embodiment, the coil spring 116 is manually compressed only when needed. Then, the conveyor belt 104 can be fed by compressing the coil spring 116 with a little force without driving the conveyor belt 104 in the reverse direction. Thus, it is possible to save an energy to a large extent without using any electric power. Moreover, there is no possibility that the coil spring 116 is compressed too much and damaged.

If the input lever 112 shown in FIG. 12 is rotated in the arrow direction A by a slight angle and returned in a reverse direction by a desired angle, the conveyor belt 104 can be moved little by little or inched. Still, even if the input lever 112 is returned in the reverse direction and stopped, the gear 21 runs idle by operation of the one-way clutch 136 provided on the gear 21. Therefore, the conveyor belt 104 does not stop at such position but continues running until the coil spring 116 is completely released and the inertia force of the drive roller 105 disappears.

### Sixth Embodiment

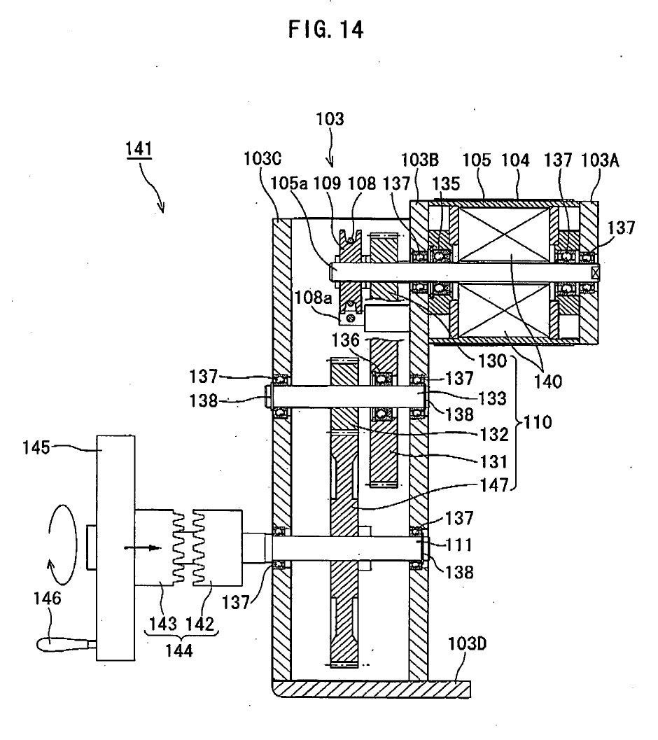

A sixth embodiment of the invention is described referring to FIG. 14. FIG. 14 is a vertical sectional view showing a structure of a drive section of a belt conveyor according to a sixth embodiment of the invention. As shown in FIG. 14, a belt conveyor 141 according to the sixth embodiment has main components similar to those of the fifth embodiment of the belt conveyor 101. Therefore, the same reference numerals or characters will be affixed to the same components, elements or parts in order to omit their description. The sixth embodiment is different from the fifth embodiment in the following points. First, a gear 147 having teeth over its entire circumference is fixed on the input shaft 111, while the gear 134 having the toothless part 134a being fixed on the input shaft 111 in the fifth embodiment. Second, a rotary handle disc 145 is provided at the end of the input shaft 111 via a clutch mechanism 144, while the input lever 112 is provided thereat in the fifth embodiment.

The clutch mechanism 144 is composed of a cylindrical gear 142 and a cylindrical gear 143. The gear 144 is fixed at the end of the input shaft 111. The rotary handle disc 145 is axially supported on the input shaft 111 so as to rotate and move forward and backward. The gear 143 is fixed on the rotary handle disc 145. In a state shown in FIG. 14, the rotary handle disc 145 is in a backward position so that the clutch mechanism 144 is in a released position. If the rotary handle disc 145 is moved forward in an arrow direction from the above position, the cylindrical gear 142 and the cylindrical gear 143 are meshed with each other so that the clutch mechanism 144 is in an engaged state. Then, if an operator holds a handle 146 to turn the rotary handle disc 145 in a right-hand direction or a clockwise direction, the input shaft 111 is rotated. Thus, a torque is transmitted to the drive shaft 105a in the same way as the fifth embodiment, so that the coil spring 116 is compressed.

In the sixth embodiment, the gear 147 fixed on the input shaft 111 has the teeth over the entire circumference. Therefore, when the input shaft 111 turns up to a compressing limit of the coil spring 116, the gear 132 never runs idle automatically or releases the coil spring 116 in contrast with the fifth embodiment. Consequently, there is a need for providing a measure for preventing the coil spring 116 from being compressed over the compressing limit and being damaged. For such purpose, a rotation range may be clearly shown or specified at the outside frame plate 103C of the third frame 103, for example. Alternatively, a stopper may be disposed in relation to the handle 146.

After the clutch mechanism 144 is engaged and the rotary handle disc 145 is turned to a desired angle within a rotation range by holding the handle 146, the rotary handle disc 145 is held with both hands so as to move backward the rotary handle disc 145 and the cylindrical gear 143. Thereby, the clutch mechanism 144 becomes in the released state. Then, the input shaft 111, the gear 147, the gear 132, the rotary shaft 133, the gear 131, the gear 130 and the drive shaft 105a are rotated in a reverse direction by the elastic force stored in the coil spring 116. Accordingly, the drive roller 105 is rotated integrally with the drive shaft 105a by the operation of the one-way clutch 135. Consequently, the conveyor belt 104 has its upper part fed out in a predetermined direction or a far side direction in FIG. 14 and its lower part fed into the drive roller 105. Thus, the conveyor belt 104 runs.

At this time, the one-way clutch 136 does not transmit the rotation of the gear 131 to the rotary shaft 133, so that the gear 131 runs idle. Accordingly, a torque of the drive shaft 105a is only wasted for rotation of the gears 130 and 131 in addition to the rotation of the drive roller 105. Therefore, the elastic energy stored in the coil spring 116 is used efficiently for driving the conveyor belt 104. Moreover, since the weight 140 is fitted inside the drive roller 105, the drive roller 105 is rotated several times more than the number of rotations by the releasing power of the coil spring 116 by an inertia force of the weight 140. Consequently, the conveyor belt 104 can be traveled at a longer distance.

As described above, in the belt conveyor 141 according to the sixth embodiment, the coil spring 116 is manually compressed only when needed. Then, the conveyor belt 104 can be fed by compressing the spiral spring 116 with a little force without driving the conveyor belt 104 in the reverse direction. Thus, it is possible to save an energy to a large extent without using any electric power. Moreover, the belt conveyor 141 can be installed at a small space since it uses the rotary handle disc 145 in place of the long input lever 112.

### Seventh Embodiment

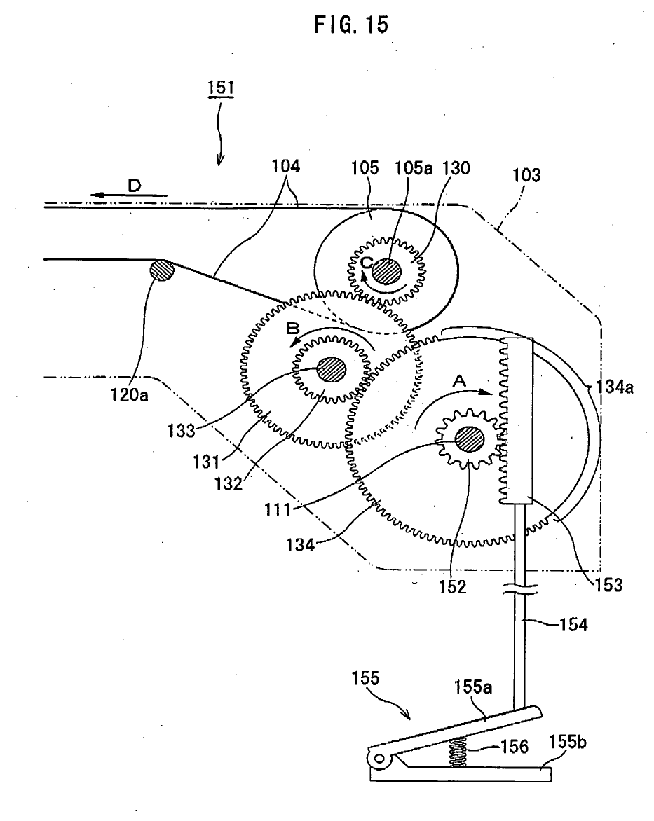

A seventh embodiment of the invention is described referring to FIG. 15. FIG. 15 is an enlarged left side elevation view showing a drive section of a belt conveyor according to a seventh embodiment of the invention. Most of components of a belt conveyor according to the seventh embodiment are similar to those of the fifth embodiment and the sixth embodiment. Therefore, the same reference numerals or characters will be affixed to the same components, elements or parts in order to omit their description.

As shown in FIG. 15, in the seventh embodiment of the belt conveyor 151, the input shaft 111 is rotated not by hand power but by foot power in contrast with the fifth and the sixth embodiments. Specifically, while the input lever 112 is fixed on the input shaft 111 in the fifth and the sixth embodiment, a pinion gear 152 is fixed on the input shaft 111 so as to rotate integrally therewith. A rack gear 153 meshing with the pinion gear 152 is fitted so as to move vertically. An elongate transmission shaft 154 is fixed vertically on a lower end of the rack gear 153 so as to reach a position near a floor surface. A lower end of the transmission shaft 154 is fitted in a rotatable manner on a step plate 155a of a step pedal 155. The step pedal 155 is disposed on the floor surface.

A compression spring 156 is attached between the step plate 155a and a bottom plate 155b of the step pedal 155. The compression spring 156 keeps its original state such that the rack gear 153, the pinion gear 152 and the gear 134 return to their original positions shown in FIG. 15, when no force is applied to the step plate 155a. If an operator presses the step plate 155a by his or her foot from the above state, the rack gear 153 is vertically lowered together with the transmission shaft 144. Then, the pinion 152 is rotated in an arrow direction A. Thus, the input shaft 111 and the gear 134 are rotated integrally so as to turn the rotary shaft 133 in an arrow direction B and the drive shaft 105a in an arrow direction C. Consequently, the second pulley 109 fitted on the drive shaft 105a is rotated so as to wind up the wire 109, thereby compressing the coil spring 116.

In the seventh embodiment, a gear ratio of the pinion gear 152 and the rack gear 153 is set such that the input shaft 111 is rotated about 150 degrees when the rack gear 153 is lowered about 10 cm. Then, if an operator presses the step plate 155a by about 10 cm, one end of the toothless part 134a of the gear 134 arrives at the meshing position of the gear 134 and the gear 132. Thereby, the gear 132 runs idle so that the coil spring 116 is released. Consequently, the drive shaft 105a and the rotary shaft 133 are rotated in reverse directions to arrow directions, respectively. Thus, the drive roller 105 is rotated integrally with the drive shaft 105a so as to feed out and drive the conveyor belt 104 in an arrow direction D. If the operator releases his or her pressing force after pushing the step plate 155a within the range of about 10 cm, the step plate 155a returns a little by a repulsive force of the compression spring 156. Then, the rack gear 153 is raised a little. Thus, it is possible to rotate the input shaft 111, the rotary shaft 133 and the drive shaft 105a in the reverse directions to the arrow directions, respectively, thereby inching the conveyor belt 104.

As described above, in the belt conveyor 151 according to the seventh embodiment, the coil spring 116 is compressed only when needed. Then, the conveyor belt 104 can be driven more safely by use of the elastic force stored in the coil spring 116. Thus, it is possible to save an energy to a large extent without using any electric power. Moreover, since the operator is free to use both hands, he or she can perform another work at the same time, while driving the belt conveyor 151.

### Eighth Embodiment

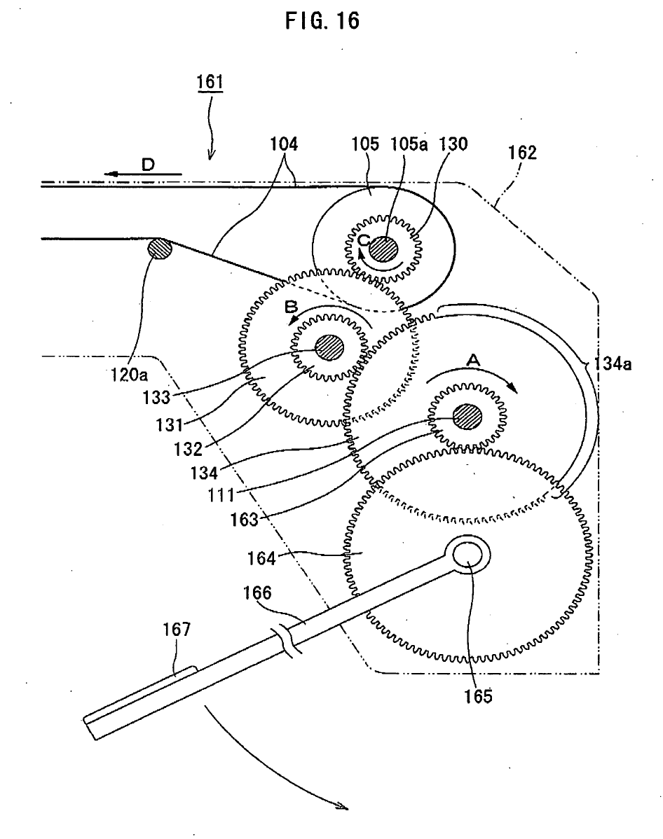

An eighth embodiment of the invention is described referring to FIG. 16. FIG. 16 is an enlarged left side elevation view showing a drive section of a belt conveyor according to an eighth embodiment of the invention. Most of components of a belt conveyor according to the eighth embodiment are similar to those of the fifth to seventh embodiments. Therefore, the same reference numerals or characters will be affixed to the same components, elements or parts in order to omit their description.

As shown in FIG. 16, in the eighth embodiment of the belt conveyor 161, the input shaft 111 is rotated not by hand power but by foot power, too. However, a step pedal 167 is mounted on a leading end of an input lever 166 in contrast with the seventh embodiment.

It is almost impossible to rotate the input lever 166 by about 150 degrees only by foot press. Therefore, a small diameter gear 163 having thirty teeth is fixed on the input shaft 111. A large diameter gear 164 having one hundred teeth is fixed on a second input shaft 165. Then, the large gear 164 is meshed with the small gear 163. The input lever 166 is secured on the second input shaft 165. Thus, the belt conveyor is structured such that, if the input lever 166 is turned about 45 degrees, the input shaft 111 is rotated about 150 degrees. Accordingly, a third frame 162 becomes large according to increase of a size of a rotating speed increasing mechanism.

With the belt conveyor 161 having such structure, if the operator presses the step pedal 167 by his or her foot, the input lever 166 is turned in an arrow direction. Then, the second input shaft 165 and the gear 164 are rotated integrally so as to make the meshed gear 163 rotate in the arrow direction A. Thereby, the input shaft 111 and the gear 134 are integrally rotated so as to turn the rotary shaft 133 in an arrow direction B and the drive shaft 105a in an arrow direction C. Consequently, the second pulley 109 attached to the drive shaft 105a is rotated to wind up the wire 108 so as to compress the coil spring 116.

If the operator turns the step pedal 167 by about 45 degrees, one end of the toothless part 134a of the gear 134 arrives at a meshing position of the gear 134 and the gear 132. Then, the gear 132 runs idle. Therefore, the coil spring 116 is released so that the drive shaft 105a and the rotary shaft 133 are rotated in the reverse directions to the arrow directions, respectively. Consequently, the drive roller 105 is rotated integrally with the drive shaft 105a so as to feed out and drive the conveyor belt 104 in an arrow direction D.

As described above, in the belt conveyor 161 according to the eighth embodiment, the coil spring 116 is compressed only when needed. Then, the conveyor belt can be driven more safely by use of the elastic force stored in the coil spring 116. Thus, it is possible to save an energy to a large extent without using any electric power. Moreover, since the operator is free to use both hands, he or she can perform another work at the same time, while driving the belt conveyor 161.

The fifth embodiment is described on an example in which the gear 134 is made of a fiber reinforced plastic or FRP. However, the gear 134 may be made of a normal steep for gears. To the contrary, the other gears 130, 131 and 132 may be made of FRP. In the sixth embodiment, the gears 130, 131, 132 and 147 may be made of FRP. In these cases, there is an advantageous effect that the rotating speed increasing mechanism becomes light and a load applied to the supporting legs 121 lessens.

Each of the fifth to eighth embodiments adopts a mechanism mainly composed of the coil spring 116 as an elastic energy storage mechanism. However, the elastic energy storage mechanism is not limited thereto. It may be composed of one using a plate spring, one that supplies compressed air by an air pump into an air cylinder having a stopper operated when it is retracted, one that compresses and expands an air cylinder by an input lever, one that mount a pinion rod on a coil spring or an air cylinder so as to directly rotate it by engagement with a pulley, or the like.

In practicing the invention of the fifth to the eighth embodiments, the spring driven belt conveyor is not limited to those of each of the above embodiments in the structure, shape, number, material, dimension, connecting relation or the like of the other components or parts.

In embodying the invention of the fifth to the eighth embodiments, the mechanism may be disposed as follows. Specifically, the coil spring 116 is compressed within a range of the compressing limit, while the conveyor belt 104 being restrained from movement. Then, the restraint of the conveyor belt 104 is released by a predetermined button operation so as to make the energy of the coil spring 116 discharged.

Particularly, in practicing the invention according to the fifth to the eighth embodiment, in case of one that stores an energy when not used and that outputs it at a burst when needed such as the one that supplies the compressed air into the air cylinder by the air pump, there is a slight recognition for manually driving when using. Moreover, it is possible to store compressed air into an air cylinder.

Since the inventive belt conveyor uses no electricity, the inventive belt conveyor according to the fifth to the eighth embodiment is applicable to a watery workplace, for example, a kitchen, a farm workplace under the scorching sun, carrying in a water tank and carrying out of the water tank in which the conveyor is put in water, a paint factory in which explosion or fire is possible in the factory, a cleansing step or a chemical factory using an organic solvent, a clean room in which static electricity is generated by a rotation of a motor and dust is attached to products, an air-conditioned temperature-controlled room that hates heat by a motor, or a food factory that hates leak of an oil or a grease oil. In the kitchen, the inventive belt conveyor according to the fifth to the eighth embodiment requires no waterproof wiring for improving electric insulation of an isolation transformer or the like even in case of delivery and receipt between the kitchen and a service room. Consequently, the belt conveyor becomes inexpensive.

When the inventive belt conveyor according to the fifth to the eighth embodiment is not driven, it does not use energy at all. Therefore, the inventive belt conveyor has a energy saving effect in contrast with the conventional belt conveyor that is always operated continuously.

The inventive belt conveyor according to the fifth to the eighth embodiments is also applicable to transport between a mixing room and a delivery room of a pharmacy or the like, delivery and receipt between a clean room and an outside, sorting work and transport after sorting in a sorting or grading place of vegetables and fruits, and, as a matter of course, to delivery from labor-intensive workplace in an assembly plant to a main conveyor, assembly and transport of parts in a group unit or the like, transport in a box or case packaged unit, an assembly plant in which layout of machines is frequently carried out, a delivery center in which sorting and delivery or the like is carried out, on-site delivery of food articles and packages when an earthquake or a typhoon is generated, or the like.

The preferred embodiments described herein are illustrative and not restrictive, the scope of the invention being indicated in the appended claims and all variations which come within the meaning of the claims are intended to be embraced therein.

1. A spring driven belt conveyor comprising:
a pair of frames separated away and opposed to each other;
a drive shaft axially supported on one of the pair of the frames;
a driven shaft axially supported on another of the pair of the frames;
a drive roller attached to the drive shaft so as to rotate integrally with the drive shaft;
a driven roller attached to the driven shaft so as to rotate integrally with the driven shaft;
an endless conveyor belt stretched between the drive roller and the driven roller so as to run;
a support, for supporting the conveyor belt, having opposite ends fixed on the pair of the frames between the drive roller and the driven roller;
a spiral spring to which the drive shaft of the drive roller is connected so as to rotate;
an input shaft axially supported on one of the pair of the frames so as to be separated away from the drive shaft;
a rotating speed increasing mechanism provided between the input shaft and the drive shaft of the drive roller so as to transmit rotation of the input shaft to the drive shaft while increasing a rotation speed thereof; and
an input member attached to the input shaft.

2. A spring driven belt conveyor according to claim 1, further comprising a one-way clutch through which the drive roller is attached to the drive shaft so that the drive roller is not rotated when the drive shaft is rotated in a direction to wind up the spiral spring, while the drive roller being rotated when the drive shaft is rotated in a direction to release the spiral spring.

3. A spring driven belt conveyor according to claim 1, in which:
the rotating speed increasing mechanism is composed of a combination of a plurality of gears including a gear fixed on the input shaft and a gear fixed on the drive shaft and rotary shaft provided respectively for the gears; and
the gear fixed on the input shaft has a toothless portion so that the gear fixed on the input shaft is disengaged from the gear meshing with the gear fixed on the input shaft at a position where the spiral spring is sufficiently wound up by operation of the input member.

4. A spring driven belt conveyor according to claim 3, in which:
the rotating speed increasing mechanism further includes a one-way clutch through which one or more of the gears other than the gear fixed on the input shaft and the gear fixed on the drive shaft among the plurality of the gears is attached to the rotary shaft so that the same gear is integrally rotated when the rotary shaft of the same gear is rotated in a direction to wind up the spiral spring, while the same gear stops transmitting a rotating force when the drive shaft is rotated in a direction to release the spiral spring.

5. A spring driven belt conveyor according to claim 1, further comprising a weight attached inside the drive roller over an entire circumference of the drive roller so as to increase inertia of he drive roller.

6. A spring driven belt conveyor according to claim 1, further comprising a plurality of supporting legs attached to opposite sides of the support so as to hold the conveyor belt at a required height.

7. A spring driven belt conveyor according to claim 1, in which the input member has an input lever having one end fixed on the input shaft.

8. A spring driven belt conveyor according to claim 1, in which the input member has a rotary handle disc attached to one end of the input shaft.

9. A spring driven belt conveyor according to claim 7, further comprising a clutch mechanism provided between the input shaft and the rotary handle disc.

10. A spring driven belt conveyor according to claim 1, in which the input member has a step pedal attached to the input shaft so as to transmit a rotating force to the input shaft.

11. A spring driven belt conveyor according to claim 7, in which the input member further has a step pedal attached to a leading end of the input lever so as to transmit a rotating force to the input shaft.

12. A belt conveyor comprising:
a pair of frames separated away and opposed to each other;
a drive shaft axially supported on the pair of the frames;
a driven shaft axially supported on the pair of the frames;
a drive roller attached to the drive shaft so as to rotate integrally with the drive shaft;
a driven roller attached to the driven shaft so as to rotate integrally with the driven shaft;
an endless conveyor belt stretched between the drive roller and the driven roller so as to run;
a support limiting a downward movement of the conveyor belt and supporting a rear surface of the conveyor belt between the drive roller and the driven roller;
an expansion-contraction energy storing mechanism being able to determining a stored state of an energy by an expansion-contraction state in a longitudinal direction; and
a rotatable pulley changing an expansion-contraction state in a longitudinal direction by the energy stored in the expansion-contraction energy storing mechanism if a human energy is applied to the expansion-contraction energy storing mechanism so as to mechanically rotate the drive roller only in a specified direction.

13. A belt conveyor comprising:
a pair of frames separated away and opposed to each other;
a drive shaft axially supported on the pair of the frames;
a driven shaft axially supported on the pair of the frames;
a drive roller attached to the drive shaft so as to rotate integrally with the drive shaft;
a driven roller attached to the driven shaft so as to rotate integrally with the driven shaft;
an endless conveyor belt stretched between the drive roller and the driven roller so as to run;
a support limiting a downward movement of the conveyor belt and supporting a rear surface of the conveyor belt between the drive roller and the driven roller;
an expansion-contraction energy storing mechanism being able to determining a stored state of an energy by an expansion-contraction state in a longitudinal direction;
a first rotatable pulley adapted to slide when the energy stored in the expansion-contraction energy storing mechanism is discharged;
a retainer provided on the pair of the frames near the drive shaft;
a second pulley fixed integrally and rotatably on the drive shaft;
a wire having one end fixed on the retainer and another end fixed on the second pulley, while being passed around the first pulley and then wound around the second pulley;
an input shaft axially supported on the pair of the frames so as to be separated away from the drive shaft;
a rotating speed increasing mechanism provided between the input shaft and the drive shaft so as to transmit rotation of the input shaft to the drive shaft while increasing a rotation speed thereof; and
an input member attached to the input shaft.

14. A belt conveyor according to claim 12, in which the expansion-contraction energy storing mechanism has a guide having a flange fixed on the pair of the frames so as to be parallel to the conveyor belt, a long rod fitted into the flanged guide so as to slide in a direction parallel to the conveyor belt, a spring holder fixed on the long rod near the driven roller, and a coil spring attached between the spring holder and the flange of the guide so as to surround the long rod.

15. A belt conveyor according to claim 12, further comprising a one-way clutch through which the drive roller is attached to the drive shaft so that the drive roller is not rotated when the drive shaft is rotated to make the expansion-contraction energy storing mechanism store the energy, while the drive roller being rotated when the drive shaft is rotated to discharge the energy stored in the expansion-contraction energy storing mechanism.

16. A belt conveyor according to claim 14, in which:
the rotating speed increasing mechanism is composed of a combination of a plurality of gears including a gear fixed on the input shaft and a gear fixed on the drive shaft and rotary shaft provided respectively for the gears; and
the gear fixed on the input shaft has a toothless portion so that the gear fixed on the input shaft is disengaged from the gear meshing with the gear fixed on the input shaft at a position where the coil spring is sufficiently compressed by operation of the input member.

17. A belt conveyor according to claim 16, in which the gear meshing with the gear fixed on the input shaft has all teeth of a part cut off corresponding to a locus drawn by a tooth edge of an end tooth next to the toothless portion of the gear fixed on the input shaft when the end tooth is again engaged with the gear.

18. A belt conveyor according to claim 16, in which:
the rotating speed increasing mechanism further includes a one-way clutch through which one or more of the gears other than the gear fixed on the input shaft and the gear fixed on the drive shaft among the plurality of the gears is attached to the rotary shaft so that the same gear is integrally rotated when the rotary shaft of the same gear is rotated in a direction to compress the coil spring, while the same gear stops transmitting a rotating force when the drive shaft is rotated in a direction to release the coil spring.

19. A belt conveyor according to claim 12, further comprising a weight attached inside the drive roller over an entire circumference of the drive roller so as to increase inertia of he drive roller.

20. A spring driven belt conveyor according to claim 12, further comprising a plurality of supporting legs attached to the support and/or at least one of the pair of the frames so as to hold the conveyor belt at a required height.

21. A belt conveyor according to claim 12, in which the input member has an input lever having one end fixed on the input shaft.

22. A belt conveyor according to claim 12, in which the input member has a rotary handle disc attached to one end of the input shaft.

23. A belt conveyor according to claim 22, further comprising a clutch mechanism provided between the input shaft and the rotary handle disc.

24. A belt conveyor according to claim 12, in which the input member has a step pedal attached to the input shaft so as to transmit a rotating force to the input shaft.

25. A belt conveyor according to claim 21, in which the input member further has a step pedal attached to a leading end of the input lever so as to transmit a rotating force to the input shaft.
